(19) United States
(12) Patent Application Publication
(10) Pub. No.: US 2025/0190135 A1
(43) Pub. Date: Jun. 12, 2025

(54) MEMORY CONTROLLER AND STORAGE DEVICE INCLUDING THE SAME

(71) Applicant: SAMSUNG ELECTRONICS CO., LTD., Suwon-Si (KR)

(72) Inventors: Siu Jung, Seoul (KR); Youngjae Kim, Seoul (KR); Seungjin Lee, Seoul (KR); Jungwook Han, Seoul (KR)

(73) Assignee: SOGANG UNIVERSITY RESEARCH & BUSINESS DEVELOPMENT FOUNDATION, Seoul (KR)

(21) Appl. No.: 18/754,350

(22) Filed: Jun. 26, 2024

(30) Foreign Application Priority Data
Dec. 11, 2023 (KR) 10-2023-0178989

(51) Int. Cl. G06F 3/06

(52) U.S. Cl. CPC G06F 3/0652; G06F 3/0604; G06F 3/064; G06F 3/0659; G06F 3/0679

(57) ABSTRACT

A storage device includes a memory device including memory blocks corresponding to physical zones; and a memory controller connected to the memory device is configured to, when receiving a zone reset command for a reset target zone, update a physical zone corresponding to the reset target zone among the physical zones to an invalid zone in a mapping table, and to trigger a block erase operation for a erase target memory block among memory blocks included in the invalid zone in a period in which a foreground operation corresponding to a foreground command is not performed, and wherein the memory controller is configured to, when receiving an additional foreground command in the period in which the block erase operation is performed on a current memory block, trigger an additional foreground operation corresponding to the additional foreground command after the block erase operation is completed.

### CROSS-REFERENCE TO RELATED APPLICATION(S)

The application claims priority under 35 U.S.C. § 119 to Korean Patent Application No. 10-2023-0178989, filed on Dec. 11, 2023, in the Korean Intellectual Property Office, the disclosure of which is herein incorporated by reference in its entirety.

### TECHNICAL FIELD

Example embodiments of the present disclosure relate to a memory controller and a storage device including the same.

### DESCRIPTION OF RELATED ART

A storage device may include a memory device and a memory controller. A plurality of memory blocks included in the memory device may be managed as a zone in the memory controller. For example, the memory controller may perform a block erase operation on the entirety of memory blocks included in the zone.

### SUMMARY

An example embodiment provides a memory controller in which a latency of a foreground operation may be reduced by, with respect to a memory block of which data has written among the memory blocks included in a zone, which is a target of zone reset, sequentially performing a block erase operation on a memory block in every period in which the foreground operation is not performed, and a storage device including the same.

According to an example embodiment, a storage device includes a memory device including a plurality of memory blocks corresponding to a plurality of physical zones; and a memory controller connected to the memory device, wherein the memory controller is configured to, when receiving a zone reset command for a reset target zone, update a physical zone corresponding to the reset target zone among the plurality of physical zones to an invalid zone in a mapping table, and to trigger a block erase operation for a erase target memory block among a plurality of memory blocks included in the invalid zone in a period in which a foreground operation corresponding to a foreground command is not performed, and wherein the memory controller is further configured to, when receiving an additional foreground command in the period in which the block erase operation is performed on a current memory block, trigger an additional foreground operation corresponding to the additional foreground command after the block erase operation for the current memory block is completed.

According to an example embodiment, a memory controller includes a host interface configured to receive a zone reset command for a reset target zone among a plurality of logical zones from a host and a foreground command from the host; a memory interface configured to control a memory device in response to the zone reset command and the foreground command; and a processor configured to communicate with the host through the host interface and to communicate with the memory device through the memory interface, wherein the processor is configured to, when the host interface receives the zone reset command, update a physical zone corresponding to the reset target zone to an invalid zone in a mapping table, wherein the processor is further configured to detect an address value of a write pointer in the invalid zone, and to select a memory block including a page mapped to an address value smaller than an address value of the write pointer from among memory blocks included in the invalid zone as an erase target memory block, and wherein the processor is further configured to trigger a block erase operation for the erase target memory block in a period in which a foreground operation corresponding to the foreground command is not performed.

According to an example embodiment, a storage device includes a memory device including a plurality of memory blocks corresponding to a plurality of physical zones; and a memory controller connected to the memory device, wherein the memory controller is configured to, when receiving a zone reset command for a reset target zone among a plurality of logical zones from a host, to update a physical zone corresponding to the reset target zone to an invalid zone in a mapping table, and to trigger a block erase operation for an erase target memory block among a plurality of memory blocks included in the invalid zone, wherein the memory controller is configured to determine a number of invalid zones and a number of free zones among the plurality of physical zones at a time of receiving the zone reset command, to compare the number of free zones with a free zone threshold value and to compare the number of invalid zones with a invalid zone threshold value, and wherein the memory controller is further configured to determine a first trigger time point of a foreground operation corresponding to a foreground command received from the host and determine a second trigger time point of a block erase operation for the erase target memory block.

### BRIEF DESCRIPTION OF DRAWINGS

Aspects, features, and advantages in the example embodiment will be more clearly understood from the following detailed description, taken in combination with the accompanying drawings, in which:

FIG. 1 is a block diagram illustrating a host-storage system according to an example embodiment of the present disclosure;

FIG. 2 is a block diagram illustrating a memory device according to an example embodiment of the present disclosure;

FIG. 3 is a diagram illustrating a 3D V-NAND structure applicable to a storage device according to an example embodiment of the present disclosure;

FIG. 4 is a block diagram illustrating a storage device according to an example embodiment of the present disclosure;

FIG. 5 is a diagram illustrating a storage space configured in a memory device according to an example embodiment of the present disclosure;

FIG. 6 is a diagram illustrating trigger conditions depending on a zone reset state of a storage device according to an example embodiment of the present disclosure;

FIG. 7 is a flowchart illustrating a trigger process of a foreground operation and a block erase operation of a storage device according to an example embodiment of the present disclosure;

FIG. 8 is a diagram illustrating a mapping table according to an example embodiment of the present disclosure;

FIG. 9 is a diagram illustrating a mapping table according to an example embodiment of the present disclosure;

FIGS. 10 to 15 are diagrams illustrating performance of a foreground operation and a block erase operation when a zone state of a storage device is a first state according to an example embodiment of the present disclosure;

FIG. 16A, FIG. 16B, FIG. 17A, and FIG. 17B are diagrams illustrating a cumulative distribution function for a foreground operation latency of a storage device according to an example embodiment of the present disclosure;

FIG. 18 is a diagram illustrating an invalid zone and a write pointer according to an example embodiment of the present disclosure;

FIG. 19A and FIG. 19B are diagrams illustrating the number of performing a block erase operation of a storage device according to an example embodiment of the present disclosure;

FIG. 20 is a flowchart illustrating a process in which a storage device performs a block erase operation according to an example embodiment of the present disclosure; and

FIG. 21 is a diagram illustrating a system to which a storage device is applied according to an example embodiment of the present disclosure.

### DETAILED DESCRIPTION

In the following detailed description, reference is made to the accompanying drawings that show, by way of illustration, particular embodiments in which the invention may be practiced. Embodiments are described in sufficient detail to enable those skilled in the art to practice the invention. It is to be understood that various embodiments of the invention, although different, are not necessarily mutually exclusive. For example, a certain feature, structure, or characteristic described herein in connection with one embodiment may be implemented within other embodiments without departing from the spirit and scope of the invention. In addition, it is to be understood that the location or arrangement of individual elements within each embodiment may be modified without departing from the spirit and scope of the invention. The following detailed description is, therefore, not to be taken in a limiting sense, and the scope of the present inventive concept is defined only by the appended claims, appropriately interpreted, along with the full range of equivalents to which the claims are entitled. In the drawings, like numerals refer to the same or similar elements or functionality throughout the several views.

Hereinafter, embodiments in the example embodiment will be described as follows with reference to the accompanying drawings.

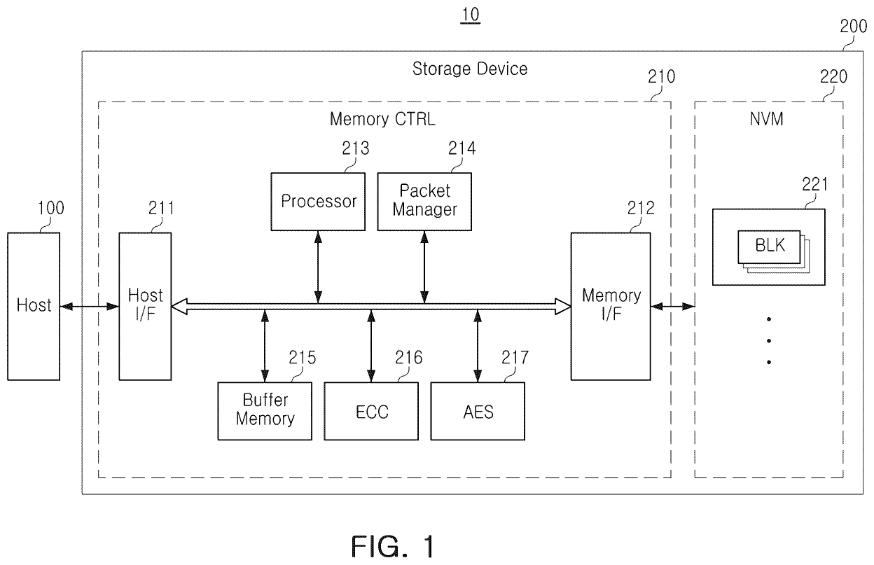

FIG. 1 is a block diagram illustrating a host-storage system according to an example embodiment.

A host-storage system 10 may include a host 100 and a storage device 200. Also, the storage device 200 may include a memory controller 210 and a memory device 220.

The host 100 may include electronic devices, for example, portable electronic devices such as a mobile phone, a MP3 player, a laptop computer, and the like, or electronic devices such as a desktop computer, a game console, a TV, projector, and the like. The host 100 may use at least one operating system (OS). The operating system may manage and control overall functions and operations of the host 100. For example, the operating system may control the hardware and software resources.

The storage device 200 may include storage media for storing data. The storage device 200 may store data according to a request from the host 100. For example, the storage device 200 may include at least one of a solid state drive (SSD), an embedded memory, or a removable external memory. When the storage device 200 is an SSD, the storage device 200 may be implemented as a device following, for example, the NVMe (nonvolatile memory express) standard. When the storage device 200 is configured as an embedded memory or an external memory, the storage device 200 may be implemented as a device following, for example, the universal flash storage (UFS) or embedded multi-media card (eMMC) standard. Each of the host 100 and the storage device 200 may generate and transmit packets in accordance with an employed protocol.

The memory device 220 may maintain stored data even when power is not supplied. The memory device 220 may store data provided from the host 100 through a write operation. The memory device 220 may output the data stored in the memory device 220 through a read operation. In an example embodiment, the memory device 220 may be a flash memory. The memory device 220 may include a plurality of memory blocks BLK. Each of the plurality of memory blocks BLK may include a plurality of pages, and each of the plurality of pages may include a plurality of memory cells connected to wordlines.

The storage space of the memory device 220 may be divided into a plurality of zones 221. Each of the plurality of zones 221 may be divided by zone units. Each of the plurality of zones 221 may include a plurality of memory blocks BLK. For example, a first zone of the plurality of zones 221 may include a first plurality of memory blocks BLK1 and a second zone of the plurality of zones 221 may include a second plurality of memory blocks BLK2.

When the memory device 220 of the storage device 200 includes a flash memory, the flash memory may include a 2D (2 dimensional) NAND memory array or a 3D (3 dimensional or vertical) NAND (VNAND) memory array. As another example, the storage device 200 may include various other types of nonvolatile memories. For example, the storage device 200 may include a magnetic RAM (MRAM), a spin-transfer torque MRAM, a conductive bridging RAM (CBRAM), a ferroelectric RAM (FeRAM), a phase RAM (PRAM), or a resistive RAM (resistive RAM), but example embodiments thereof are not limited thereto. For example, various other types of memories may be applied.

The memory controller 210 may control the memory device 220 in response to a request from the host 100. For example, the memory controller 210 may provide data read from the memory device 220 to the host 100 and may write the data provided from the host 100 to the memory device 220. Alternatively, the memory controller 210 may erase data stored in the memory device 220.

The memory controller 210 may include a host interface 211, a memory interface 212 and a processor 213. Also, the memory controller 210 may further include a packet manager 214, a buffer memory 215, an error correction code (ECC) 216 engine and an advanced encryption standard (AES) 217 engine.

Host interface 211 may transmit a packet to and receive a packet from the host 100. The packet transmitted from the host 100 to the host interface 211 may include a command or data to be written in the memory device 220, and the packet transmitted from the host interface 211 to the host 100 may include a response to a command or data read from the memory device 220.

The memory interface 212 may transmit data to be written to the memory device 220 to the memory device 220, or may receive data read from the memory device 220. The memory interface 212 may be implemented to comply with standard protocols such as toggle or open NAND flash interface (ONFI).

The processor 213 may perform an operation of controlling the memory controller 210 and may control operation of the memory device 220. The processor 213 may communicate with the host 100 through the host interface 211. The processor 213 may communicate with the memory device 220 through the memory interface 212.

In an example embodiment, the processor 213 may perform a function of a flash translation layer FTL. The processor 213 may convert a logical address received from the host 100 into a physical address used to actually store data in the memory device 220 through the flash translation layer.

There may be several address mapping methods of the flash translation layer depending on a mapping unit. Representative address mapping methods may include a page mapping method, a block mapping method, or a hybrid mapping method.

The processor 213 may randomize data received from the host HOST, and the randomized data may be provided to the memory device 220 and may be written to the memory cell array. The processor 213 may derandomize data received from the memory device 220 during a read operation, and the derandomized data may be output to the host 100.

The processor 213 may control operation of the memory controller 210 by executing firmware. In other words, the processor 213 may execute firmware loaded into a working memory (not illustrated) and may control various operations of the memory controller 210 and may perform a logical operation.

Firmware may be a program performed in the storage device 200 and may include various functional layers. For example, the firmware may include a flash translation layer FTL performing a translation function between a logical address used to request access to the storage device 200 from the host 100 and a physical address of the memory device 220. Also, the firmware may further include a host interface layer (HIL) interpreting commands requested from the host 100 to the storage device 200 and may transmit the commands to the flash translation layer FTL, and a flash interface layer (FIL) transmitting commands from the flash translation layer FTL to the memory device 220.

As an example, the firmware may be stored in the memory device 220 and may be loaded into a working memory. The working memory may store firmware, program codes, commands, or data necessary to drive the memory controller 210. The working memory according to an example embodiment may be implemented as a volatile memory and may include one or more of a static RAM (SRAM), a dynamic RAM (DRAM) and a synchronous DRAM (SDRAM).

The packet manager 214 may generate a packet according to a protocol of an interface negotiated with the host 100, or may parse various data from a packet received from the host 100. Also, the buffer memory 215 may temporarily store data to be written to the memory device 220 or data to be read from the memory device 220. The buffer memory 215 may be provided in the memory controller 210, or may also be disposed externally of the memory controller 210.

The ECC engine 216 may perform a function of detecting and correcting errors on read data read from the memory device 220. More specifically, the ECC engine 216 may generate parity bits for written data to be written to the memory device 220, and the parity bits generated as above may be stored in the memory device 220 along with the written data. When data is read from the memory device 220, the ECC engine 216 may correct errors in the read data using parity bits read from the memory device 220 along with the read data, and may output read data of which an error has been corrected.

The AES engine 217 may perform at least one of an encryption operation or a decryption operation on data input to the memory controller 210 using a symmetric-key algorithm.

As for the file system of the host 100, a storage space of the storage device 200 may be managed by being divided by zone units. For example, the host 100 may perform sequential writing in a zone and may perform a zone reset with a zone unit. The zone managed by the host 100 may have a corresponding relationship with the zone managed by the storage device 200, but the corresponding relationship may be varied.

A zone managed by the host 100 may be referred to as a logical zone. A zone managed by the storage device 200 may be referred to as a physical zone. Accordingly, the zone managed by the host 100 and the zone managed by the storage device 200 may be distinguished. In an example embodiment, the mapping table may indicate a corresponding relationship between the logical zone and the physical zone, and a state of the physical zone. A physical zone mapped to a logical zone may be an allocated zone state. A physical zone not mapped to a logical zone may be a free zone state. Although the written data has not been erased, the physical zone in which the data is no longer valid may be an invalid zone state.

When the memory controller 210 receives a zone reset command for the reset target zone among the logical zones from the host 100, the memory controller 210 may perform a block erase operation on the physical zone corresponding to a reset target zone in the mapping table. The block erase operation may not be performed immediately in response to receiving a zone reset command.

Specifically, when the memory controller 210 receives a zone reset command, the memory controller 210 may update the physical zone corresponding to the reset target zone to an invalid zone in the mapping table. Also, the memory controller 210 may newly allow a physical zone among free zones not having a corresponding relationship in the mapping table to correspond to a reset target zone. The memory controller 210 may update the mapping table such that the free zone having a new corresponding relationship may be updated as an allocated zone. Thereafter, the memory controller 210 may perform a block erase operation for the invalid zone. The invalid zone for which the block erase operation is completed may be updated as a free zone in the mapping table.

When the memory controller 210 performs a block erase operation on the entirety of the memory block included in the invalid zone, the foreground operation may be delayed until the block erase operation is completed, such that, as the number of memory blocks on which a block erase operation is performed increases, the latency of the foreground operation may increase. Also, a block erase operation may be performed on memory blocks in which data is not written, which may reduce the lifespan of the memory block.

It should be understood that some types of memory devices have limited lifespans. For example, a memory device may become less reliable with usage as transistors wear out and lose a charge-holding capacity. With usage over time, these memory devices may become less reliable. Accordingly, example embodiments may increase a lifespan of the memory block by limiting or eliminating avoidable usage, such as a block erase operation on a memory block in which data is not written.

The memory controller 210 in an example embodiment may sequentially trigger block erase operations for memory blocks included in the invalid zone, respectively, in every period in which a foreground operation corresponding to the foreground command received from host 100 is not performed. In other words, by distributing the time when the block erase operation is performed, the latency of the foreground operation may be reduced. That is, a delay in the foreground operation may be reduced or eliminated.

Also, the memory controller 210 in an example embodiment may perform a block erase operation only on memory blocks in which data is written among memory blocks included in the invalid zone with reference to an address value of a write pointer of the invalid zone. In other words, by not performing a block erase operation on a memory block in which data is not written, a lifespan of the memory block may be protected and a lifespan of the storage device 200 may be improved.

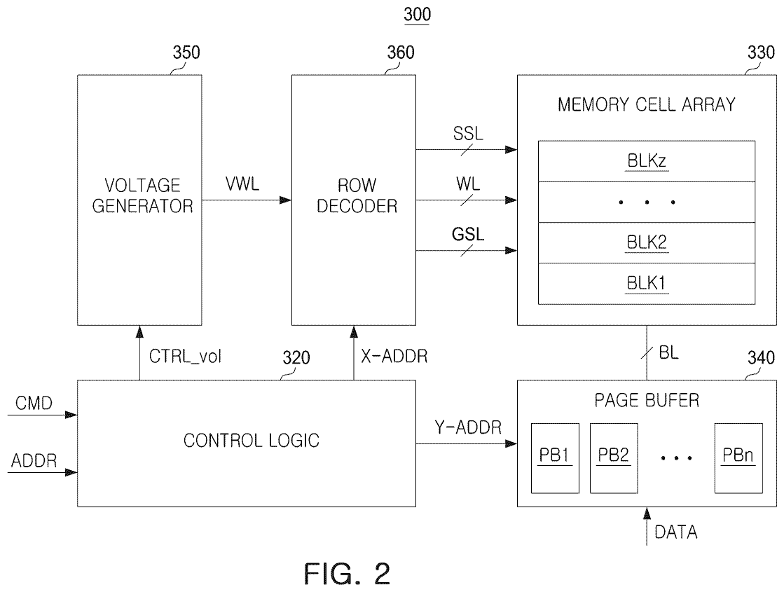

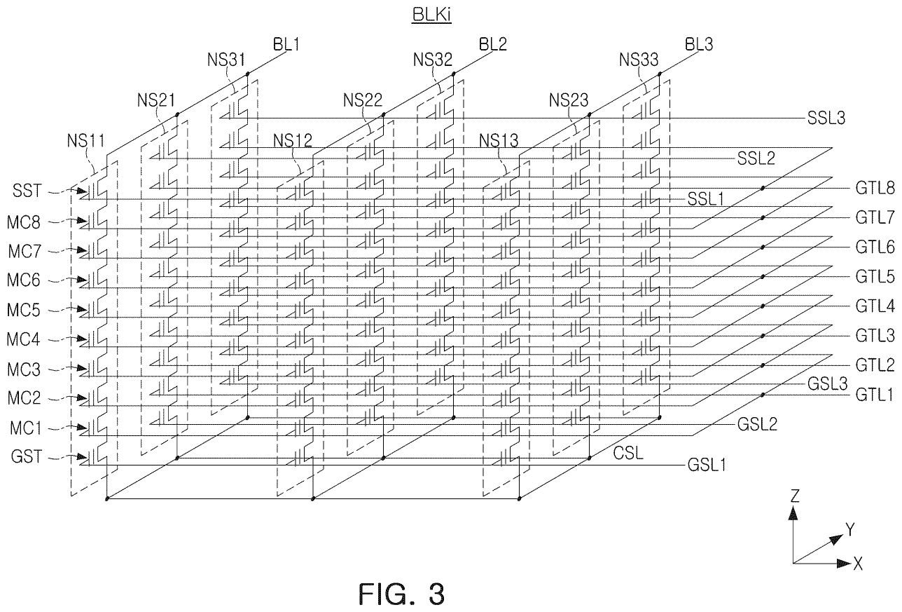

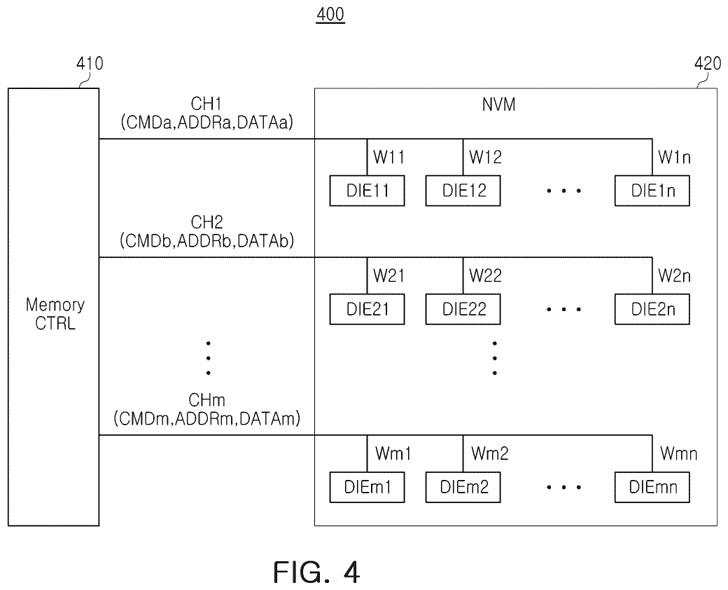

In the description, before describing the storage device 200 according to an example embodiment, memory blocks included in the memory device 220 will be described in greater detail. FIG. 2, FIG. 3, and FIG. 4 are diagrams further illustrating memory blocks included in a memory device according to an example embodiment. However, example embodiments are not limited thereto, and other memory structures may be implemented.

FIG. 2 is a block diagram illustrating a memory device according to an example embodiment.

Referring to FIG. 2, the memory device 300 may include a control logic circuit 320, a memory cell array 330, a page buffer 340, a voltage generator 350, and a row decoder 360. Although not illustrated in FIG. 2, the memory device 300 may further include a memory interface circuit for receiving a command CMD and an address ADDR from an external entity and exchanging data DATA from an external entity, and may further include a column logic, a pre-decoder, a temperature sensor, a command decoder, an address decoder, or the like.

The control logic circuit 320 may control various operations in the memory device 300. The control logic circuit 320 may output various control signals in response to the command CMD and/or the address ADDR from the memory interface circuit 310. For example, the control logic circuit 320 may output a voltage control signal CTRL_vol, a row address X-ADDR, and a column address Y-ADDR.

The memory cell array 330 may include a plurality of memory blocks BLK1-BLKz (z is a positive integer), and each of the plurality of memory blocks BLK1-BLKz may include a plurality of memory cells. The memory cell array 330 may be connected to the page buffer 340 through bitlines BL and may be connected to the row decoder 360 through wordlines WL, string select lines SSL, and ground select lines GSL.

As an example, the memory cell array 330 may include a three-dimensional memory cell array, and the three-dimensional memory cell array may include a plurality of NAND strings. Each of the NAND strings may include memory cells connected to wordlines stacked vertically on the substrate, respectively. In an example embodiment, the memory cell array 330 may include a two-dimensional memory cell array, and the two-dimensional memory cell array may include a plurality of NAND strings disposed along row and column directions.

The page buffer 340 may include a plurality of pages buffers (PB1-PBn) (n is an integer of 3 or more), and the plurality of pages buffers (PB1-PBn) may be connected to memory cells through the plurality of bitlines BL, respectively. The page buffer 340 may select at least one bitline from among the bitlines BL in response to the column address Y-ADDR. The page buffer 340 may operate as a write driver or a sense amplifier depending on an operation mode. For example, during a write operation, the page buffer 340 may apply a bitline voltage corresponding to data to be written to the selected bitline. During a read operation, the page buffer 340 may sense the data stored in the memory cell by sensing a current or a voltage of the selected bitline.

The voltage generator 350 may generate various types of voltages to perform write, read, and erase operations based on the voltage control signal CTRL_vol. For example, the voltage generator 350 may be configured as a wordline voltage VWL and may generate a write voltage, a read voltage, a write verification voltage, an erase voltage, or the like.

The row decoder 360 may select one of the plurality of wordlines WL and one of the plurality of string select lines SSL in response to the row address X-ADDR. For example, the row decoder 360 may apply a write voltage and a write verification voltage to the selected wordline during a write operation, and may apply a read voltage to the selected wordline during a read operation.

FIG. 3 is a diagram illustrating a 3D V-NAND structure applicable to a storage device according to an example embodiment. When the memory device of the storage device is implemented as a 3D V-NAND flash memory, each of the plurality of memory blocks included in the memory device may be represented as an equivalent circuit as illustrated in FIG. 3.

FIG. 3 is a diagram illustrating a 3D V-NAND structure applicable to a storage device according to an example embodiment.

For example, a plurality of memory NAND strings included in the memory block BLKi may be formed in a direction perpendicular to a substrate.

Referring to FIG. 3, memory block BLKi may include a plurality of memory NAND strings NS11-NS33 connected between bitlines BL1, BL2, and BL3 and a common source line CSL. Each of the plurality of memory NAND strings NS11-NS33 may include a string select transistor SST, a plurality of memory cells MC1, MC2, . . . , MC8 and a ground select transistor GST. In FIG. 3, the plurality of memory NAND strings NS11-NS33 may include eight memory cells MC1, MC2, . . . , MC8, but example embodiments thereof are not limited thereto.

The string select transistor SST may be connected to the corresponding string select lines SSL1, SSL2, and SSL3. The plurality of memory cells MC1, MC2, . . . , MC8 may be connected to the corresponding gate lines GTL1, GTL2, . . . , GTL8, respectively. The gate lines GTL1, GTL2, . . . , GTL8 may correspond to wordlines, and a portion of the gate lines GTL1, GTL2, . . . , GTL8 may correspond to dummy wordlines. The ground select transistor GST may be connected to the corresponding ground select lines GSL1, GSL2, and GSL3. The string select transistor SST may be connected to the corresponding bitlines BL1, BL2, and BL3, and the ground select transistor GST may be connected to the common source line CSL.

Wordlines (for example, WL1) on the same level may be connected in common, and the ground select lines GSL1, GSL2, GSL3 and the string select lines SSL1, SSL2, and SSL3 may be isolated from each other, respectively. In FIG. 3, the memory block BLKi may be connected to eight gate lines GTL1, GTL2, . . . , GTL8 and three bitlines BL1, BL2, and BL3, but example embodiments thereof are not limited thereto.

FIG. 4 is a block diagram illustrating a storage device according to an example embodiment.

Referring to FIG. 4, the storage device 400 may include a memory controller 410 and a memory device 420. The storage device 400 may support a plurality of channels CH1-CHm (CH1, CH2, . . . , CHm), and the memory controller 410 and the memory device 420 may be connected to each other through the plurality of channels CH1-CHm.

A memory device 420 may correspond to a nonvolatile memory NVM, and the nonvolatile memory NVM may include a plurality of memory dies DIE11-DIEmn (DIE11, DIE12, . . . , DIEIn, DIE21, DIE22, . . . , DIE2n, . . . , DIEm1, DIEm2, . . . , DIEmn). Each of the plurality of memory dies DIE11-DIEmn may be configured as a NAND memory die. The plurality of memory dies DIE11-DIEmn may be connected to one of the plurality of channels CH1-CHm through ways W11-Wmn (W11, W12, . . . , W1n, W21, W22, . . . , W2n, . . . , Wm1, Wm2, . . . , Wmn) corresponding to the memory dies DIE11-DIEmn, respectively. In an example embodiment, each of the plurality of dies DIE11-DIEmn may be implemented as an arbitrary memory unit which may operate in response to an individual command from the memory controller 410.

Each of the memory dies DIE11-DIEmm may include a plurality of planes, and the plurality of planes may process a command received by a memory die in parallel. Each of the planes may include a plurality of memory blocks, and a memory block may include a plurality of pages. In an example embodiment, a memory block may correspond to a minimum unit of a data erase operation, and a page may correspond to a minimum unit of a data write operation.

The memory controller 410 may transmit signals to and receive signals from the memory device 420 through the plurality of channels CH1-CHm. The memory controller 410 may transmit, to the memory device 420, commands CMDa, CMDb, . . . , CMDm, addresses ADDRa, ADDRb, . . . , ADDRm, and data DATAa, DATAb, . . . , DATAm through the plurality of channels CH1-CHm, or may receive the from the memory device 420. In an example embodiment, the memory controller 410 may select a memory die DIE11 connected to the first channel CH1. The memory controller 410 may transmit/receive the command CMDa, the address ADDRa and data DATAa to/from the selected memory die DIE11.

The memory controller 410 may transmit signals to, and receive signals from the memory device 420 in parallel through different channels. In an example embodiment, the memory controller 410 may transmit the command CMDb to the memory device 420 or may receive the data DATAb through the second channel CH2 while transmitting the command CMDa to or receiving the data DATAa from the memory device 610 through the first channel CH1. In other words, the plurality of memory dies DIE11-DIEmn may operate in parallel with each other.

The memory controller 410 may control overall operations of the memory device 420. The memory controller 410 may control each of the memory dies DIE11-DIEmn connected to the channels CH1-CHm by transmitting a signal to the channels CH1-CHm. Each of the memory dies DIE11-DIEmn may operate under control of the memory controller 410.

Referring to FIG. 4, the memory device 420 may communicate with the memory controller 410 through m channels, and the memory device 420 may include an n memory dies corresponding to each channel, wherein m and n are positive integers. The numbers m and n may be a same number or different numbers.

The storage device 400 according to an example embodiment may operate based on, for example, the NVMe protocol and may support a namespace and/or a zoned namespace (ZNS). NVMe may be a register-level interface communicating between a storage device such as an SSD and host software. NVMe may be based on the PCIe bus or CXL bus and may be an interface optimized for an SSD. When the namespace function is used, the storage space provided by a storage device, which may be a single physical device, may be divided into a plurality of namespaces and data may be managed based on the namespace.

When the ZNS function is used, the storage device 400 may configure a storage space provided by the plurality of physical zones to be a namespace and may manage data based on the namespace and the zone. The plurality of namespaces and the physical zones may be included physically the same storage device 400, and each namespace and each physical zone may be used as an individual storage space.

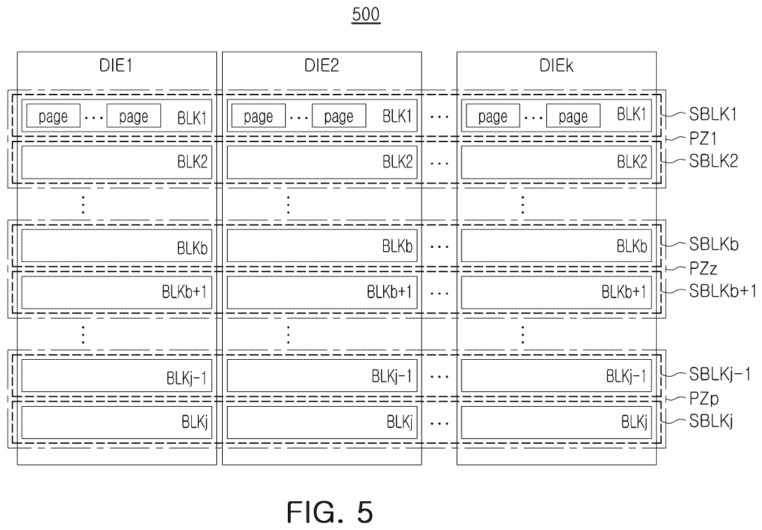

In the description, the physical zones included in the storage device 400 may be described in greater detail with reference to FIG. 5.

FIG. 5 is a diagram illustrating a storage space configured in a memory device according to an example embodiment.

Referring to FIG. 5, the memory device 500 may include a plurality of memory blocks BLK1-BLKj (BLK1, BLK2, . . . , BLKb, BLKb+1, . . . , BLKj-1, BLKj). Each of the plurality of memory blocks BLK1-BLKj may include a plurality of pages. Each of the plurality of super memory blocks SBLK1-SBLKj (SBLK1, SBLK2, . . . , SBLKb, SBLKb+1, . . . , SBLKj-1, SBLKj) may include memory blocks on which a block erase operation may be performed in parallel. A plurality of physical zones PZ1-PZp (PZ1, . . . , PZz, . . . , PZp) may include at least one super memory block SBLK. Each of the plurality of physical zones PZ1-PZp may correspond to a storage space divided by the memory device 500 by zone units.

The memory device 500 may include plurality of memory dies DIE1-DIEk (DIE1, DIE2, . . . , DIEk). The plurality of memory dies DIE1-DIEk may be included in the memory device 500, and the plurality of the memory dies DIE1-DIEk may include a plurality of memory blocks BLK1-BLKj, respectively.

Specific example embodiments of the memory device 500 and the plurality of memory dies DIE1-DIEk may be similar to examples described with reference to FIGS. 1 and 4. Referring to FIG. 4 as an example embodiment, the plurality of memory dies DIE1-DIEk may be connected to the same channel among the plurality of channels CH1-CHm in FIG. 4. In another example embodiment, referring to FIG. 4, at least one of the plurality of memory dies DIE1-DIEk may be connected to another channel among the plurality of channels CH1-CHm in FIG. 4. The number (k) of the plurality of memory dies DIE1-DIEk may be the same as or different from the number (n) of the memory dies connected to the same channel among the plurality of channels CH1-CHm in FIG. 4.

Each of the plurality of memory dies DIE1-DIEk may include a same number of memory blocks, and as in an example embodiment illustrated in FIG. 5, the plurality of memory dies DIE1-DIEk may include the same number (j) of memory blocks BLK1-include BLKj. The number (k) of the plurality of memory blocks DIE1-DIEk may be the same as or different from the number (j) of the plurality of memory blocks BLK1-BLKj. However, example embodiments thereof are not limited thereto. For example, in another example embodiment, at least one memory die may include a different number of memory blocks.

In an example embodiment illustrated in FIG. 5, the memory device 500 may be divided into the plurality of physical zones PZ1-PZp. Each of the plurality of physical zones PZ1-PZp may correspond to a storage space divided by the memory device 500 by zone units. For example, the plurality of physical zones PZ1-PZp may be configured as storage spaces provided by the plurality of memory blocks BLK1-BLKj, respectively. In other words, the notion that the physical zone is configured as storage spaces provided by the plurality of memory blocks may also indicate that the physical zone may include a plurality of memory blocks.

In an example embodiment, the number (p) of the plurality of physical zones PZ1-PZp included in the memory device 500 may be less than or equal to the number (j) of the plurality of memory blocks BLK1-BLKj. Also, capacity of the plurality of physical zones PZ1-PZp may be the same, or capacity of at least one physical zone may be different. However, the generation and configuration of the plurality of physical zones PZ1-PZp may be varied, differently from an example illustrated in FIG. 5.

Each of the plurality of physical zones PZ1-PZp may include at least one super memory block. In an example embodiment illustrated in FIG. 5, each of the plurality of physical zones PZ1-PZp may be configured in a partial region of each of the plurality of memory dies DIE1-DIEk. The first physical zone PZ1 may include a first super memory block SBLK1 and a second super memory block SBLK2. The first super memory block SBLK1 may include the first memory block BLK1 of each of the plurality of memory dies DIE1-DIEk. The second super memory block SBLK1 may include a second memory block BLK2 of each of the plurality of memory dies DIE1-DIEk. In other words, the plurality of memory blocks BLK1-BLKj may be included in the plurality of physical zones PZ1-PZp.

In another example embodiment, each of the plurality of physical zones PZ1-PZp may configure memory blocks included in one of the plurality of memory dies DIE1-DIEk as one physical zone. However, example embodiments thereof are not limited thereto.

Each of the super memory blocks SBLK1-SBLKj may include at least one memory block, and the memory blocks included in the super memory block may be accessed simultaneously. In an example embodiment illustrated in FIG. 5, the first memory blocks BLK1 included in each of the plurality of memory dies DIE1-DIEk may be included in the first super memory block SBLK1, and the first memory blocks BLK1 may be accessed simultaneously.

In an example embodiment, each of the plurality of physical zones PZ1-PZp may include a write pointer. A write pointer may specify a position in a physical zone. The write pointer may specify a position in the physical zone at which data is to be written. When a page corresponds to a unit of memory management, the write pointer may be mapped to a page address value. In other words, data may be written in pages (programmed pages) mapped to an address value smaller than an address value of the write pointer among the memory blocks included in the physical zone. When a write operation is triggered on a page mapped to an address value of the write pointer, the write pointer may move to a page in which subsequent data is to be written. The page may correspond to a smallest unit of memory management.

In the description, a unit of the block erase operation may be referred to as a memory block. For example, the memory block may be a smallest unit of the block erase operation. As an example, when a block erase operation is performed as a memory block BLK unit, the memory block may refer to one of the plurality of memory blocks BLK1-BLKj. As another example, when a block erase operation is performed by a super memory block SBLK unit, the memory block may refer to one of the plurality of super memory blocks SBLK1-SBLKj.

In the description, memory blocks may have memory addresses. The memory addresses of the memory blocks may be sequential. The memory address of the memory blocks may be unique among the plurality of memory blocks. For example, a first memory block may have an address that is smaller than or larger than an address of a second memory block. That is, a small address may appear earlier or before a large address in an address space. Conversely, the large address may appear subsequent to, or after the small address in the address space.

The storage device according to an example embodiment may include a memory device in an example embodiment illustrated in FIG. 5, and specific example embodiments thereof may be similar to examples described with reference to FIGS. 1 to 4. As the storage device receives a zone reset command, the storage device may update a physical zone corresponding to a reset target zone among the logical zones to an invalid zone in the mapping table. Also, the storage device may select a memory block including a page mapped to an address value smaller than the address value of the write pointer as an erase target memory block among memory blocks included in the invalid zone. The storage device may sequentially trigger block erase operations for erase target memory blocks, respectively, in every period in which a foreground operation corresponding to the foreground command is not performed. Accordingly, latency of the foreground operation may be reduced, lifespan of the memory block may be protected, and lifespan of the storage device may be improved.

Conditions under which the block erase operation is triggered may be adjusted depending on a size of the free storage space of the storage device.

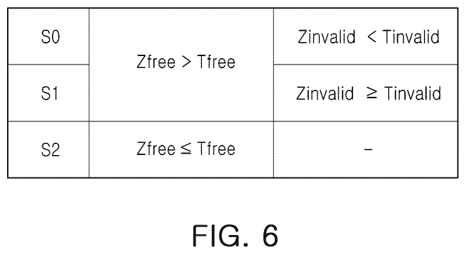

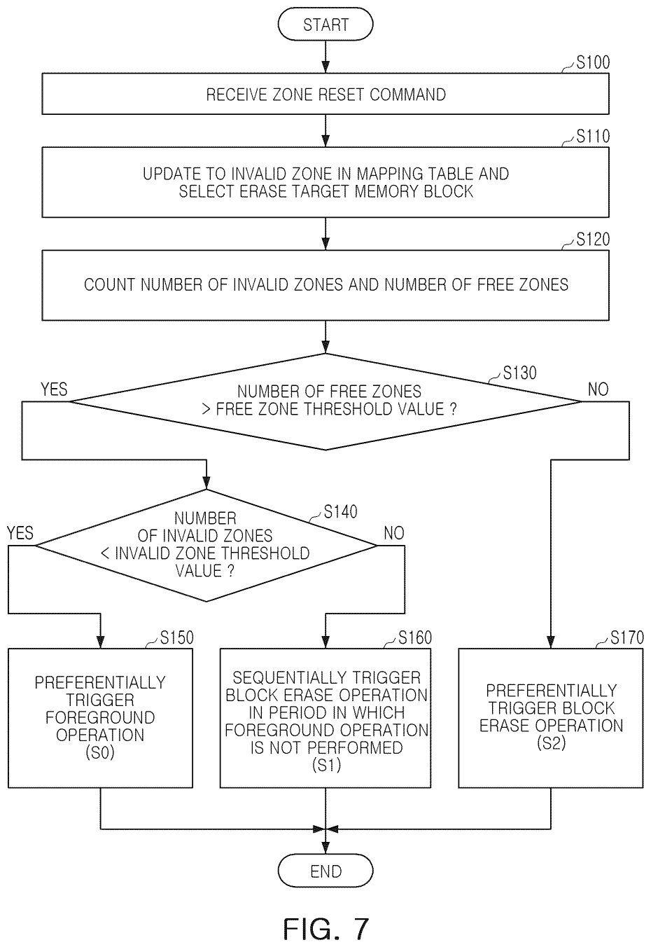

FIG. 6 is a diagram illustrating trigger conditions depending on a zone reset state of a storage device according to an example embodiment. FIG. 7 is a flowchart illustrating a trigger process of a foreground operation and a block erase operation of a storage device according to an example embodiment.

The storage device in an example embodiment may include a memory device and a memory controller. The memory device may include a plurality of memory blocks corresponding to a plurality of physical zones. The memory controller may include a host interface receiving a zone reset command and a foreground command from a host, a memory interface controlling a memory device in response to the zone reset command and the foreground command, and a processor communicating with the host through the host interface and communicating with the memory device through the memory interface. The Specific example embodiments may be similar to examples described with reference to FIG. 1.

To prevent performance degradation of the foreground operation, the memory controller may vary trigger conditions of a background operation to ensure a storage space depending on a size of the free storage space of the memory device. To determine the trigger conditions of the background operation, the memory controller may compare the number Zinvalid of invalid zones at the time of receiving a zone reset command and the number Zfree of free zones with a predetermined invalid zone threshold value Tinvalid and a free threshold zone value Tfree. In an example embodiment, a sum of the invalid zone threshold value Tinvalid and the free zone threshold value Tfree may be less than the number of plurality of physical zones, but example embodiments thereof is not limited thereto.

Referring to FIG. 7, the host interface may receive a zone reset command for a reset target zone among logical zones from the host (S100). The processor may update the physical zone corresponding to the reset target zone to an invalid zone in the mapping table and may select at least one erase target memory block from among the memory blocks included in the invalid zone (S110). The processor may count the number Zinvalid of invalid zones and the number Zfree of free zones at the time when the host interface receives the zone reset command among the plurality of physical zones (S120).

Referring to FIG. 6 and FIG. 7, the memory controller may determine a zone reset state (among zero to second states S0-S2) according to a result of the trigger condition. In other words, the processor may determine a first trigger time point for a foreground operation corresponding to the foreground command received from the host and may determine a second trigger time point for a block erase operation for the erase target memory block using the result of the trigger condition. Specifically, the trigger condition may include a result of comparison between the number Zfree of free zones and the free zone threshold value Tfree, and/or a result of comparison between the number Zinvalid of invalid zones and the invalid zone threshold value Tinvalid. For example, whether the comparison between the number Zinvalid of invalid zones and the invalid zone threshold value Tinvalid is performed may depend on the result of the comparison between the number Zfree of free zones and the free zone threshold value Tfree.

Referring to FIG. 6 and FIG. 7, the zone reset state may be divided into a zero state (S0), a first state (S1), and a second state (S2).

The zero state (S0) may be a state in which the number Zfree of free zones is greater than the free zone threshold value Tfree, and the number Zinvalid of invalid zones is less than the invalid zone threshold value Tinvalid, and may be a state in which the free storage space of the storage device is sufficient. Accordingly, the memory controller in the zero state (S0) may preferentially trigger a foreground operation over a block erase operation for the entirety of erase target memory blocks.

The first state (S1) may be a state in which the number Zfree of free zones is greater than the free zone threshold value Tfree, and the number Zinvalid of invalid zones is greater than or equal to the invalid zone threshold value Tinvalid, and may be a state in which the storage device may have a sufficient free storage space, but the number of invalid zones which may not be used as free storage space has increased. Accordingly, the memory controller in the first state (S1) may sequentially trigger block erase operations for erase target memory blocks, respectively, in every period in which the foreground operation is not performed.

The second state (S2) may be a state in which the number of free zones Zfree is less than or equal to the free zone threshold value Tfree, and may be a state in which the free storage space of the storage device is insufficient. Accordingly, the memory controller in the second state (S2) may preferentially trigger a block erase operation for the entirety of erase target memory blocks. The memory controller in the second state (S2) may preferentially trigger a block erase operation for the entirety of erase target memory blocks, rather than the foreground operation.

Referring to FIG. 7, the memory controller may compare the number of free zones Zfree with the free zone threshold value Tfree. Specifically, the processor may determine whether the number of free zones Zfree is greater than the free zone threshold value Tfree (S130). Referring to FIG. 6 and FIG. 7, when the number of free zones Zfree is less than or equal to the free zone threshold value Tfree (NO in S130), the processor may suspend the foreground operation and may preferentially trigger the block erase operation (S2 in FIGS. 6 and S170 in FIG. 7).

Referring to FIG. 7, when the number of free zones Zfree is greater than the free zone threshold value Tfree (YES in S130), the memory controller may compare the number of invalid zones Zinvalid with the invalid zone threshold value Tinvalid. Specifically, the processor may determine whether the number Zinvalid of invalid zones is less than the invalid zone threshold value Tinvalid (S140).

Referring to FIG. 6 and FIG. 7, in an example embodiment, when the number of invalid zones Zinvalid is less than the invalid zone threshold value Tinvalid (YES in S140), the processor may suspend a block erase operation and may preferentially trigger the foreground operation (zero state S0 in FIGS. 6 and S150 in FIG. 7). In another example embodiment, when the number of invalid zones Zinvalid is greater than or equal to the invalid zone threshold value Tinvalid (NO in S140), the memory controller may sequentially trigger block erase operations in the period in which the foreground operation is not performed (first state S1 in FIGS. 6 and S160 in FIG. 7).

A storage device according to an example embodiment may determine the zone reset state (among zero to second states S0-S2) of an invalid zone according to a result of the trigger condition. In other words, depending on a size of the free storage space of the memory device, priority between the foreground operation and the block erase operation may be determined. Accordingly, by distributing the foreground operation and the block erase operation, availability of a storage space may be ensured efficiently.

To determine which zone state a specific physical zone corresponds to among the invalid zone, the free zone, and the assigned zone, and to determine the number Zinvalid of invalid zones and the number Zfree of free zones among the plurality of physical zones, a mapping table may be used.

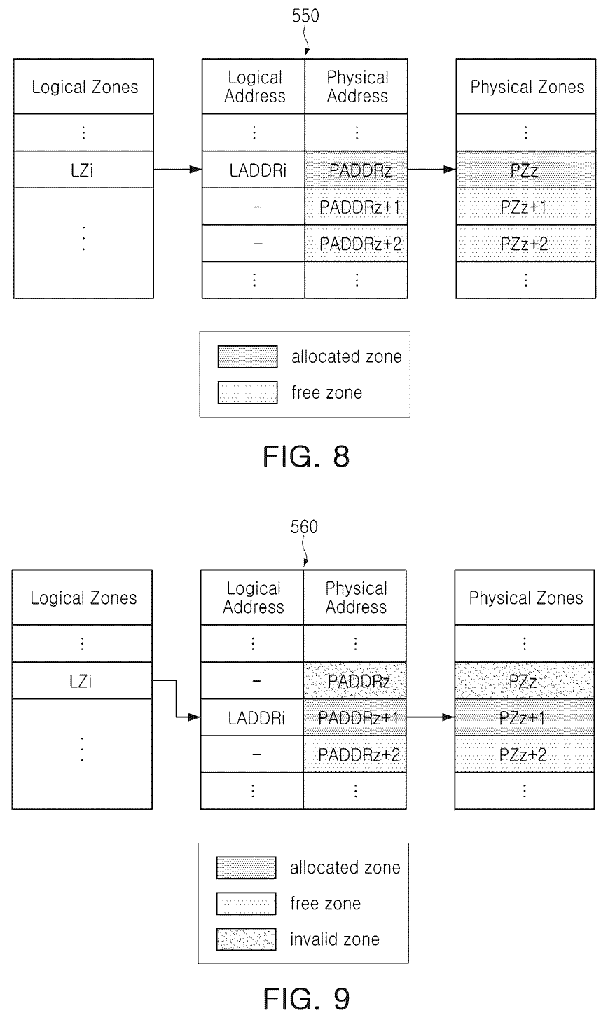

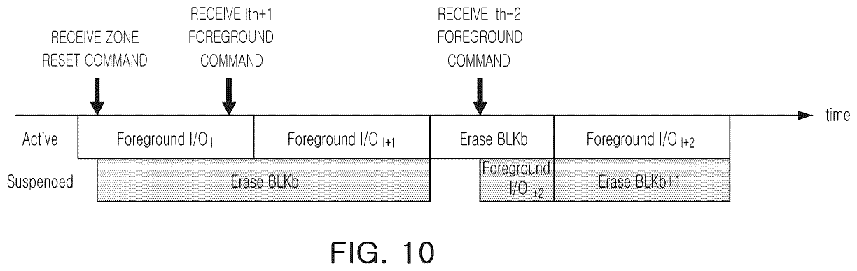

FIG. 8 is a diagram illustrating a mapping table according to an example embodiment. FIG. 9 is a diagram illustrating a mapping table according to an example embodiment.

In an example embodiment, the storage device may include a memory device and a memory controller. The memory device may be divided into a plurality of physical zones. Each of the plurality of physical zones may include a plurality of memory blocks. Each of the plurality of physical zones may correspond to a storage space obtained by dividing the memory device by zone units.

In an example embodiment, the memory controller may perform a function of the flash translation layer FTL. Through the flash translation layer FTL, the memory controller may convert a logical address of the logical zone received from a host into a physical address of the physical zone used to actually store data in the memory device.

The mapping tables 550 and 560 illustrated in FIG. 8 and FIG. 9, respectively, may indicate the corresponding relationship between the logical zone and the physical zone according to example embodiments. Specifically, the mapping tables 550 and 560 may store the corresponding relationship between the logical address and the physical address and the state of the physical zone corresponding to the physical address. As illustrated in FIG. 8 and FIG. 9, the corresponding relationship between the logical zone and the physical zone may be stored in a table. Example embodiments thereof are not limited thereto. For example, the corresponding relationship may be defined as a hash or a function.

Referring to FIG. 8, an ith logical zone LZi may have an ith logical address LADDRi, and a zth physical zone PZz may have a zth physical address PADDRz. The ith logical address LADDRi of the ith logical zone LZi may correspond to the zth physical address PADDRz of the zth physical zone PZz. In other words, the ith logical zone LZi may be mapped with the zth physical zone PZz.

In an example embodiment illustrated in FIG. 8, at least one of the zth-zth+2 physical zones PZz-PZz+2 may have a different zone state, but example embodiments thereof are not limited thereto.

In the case that the zth physical zone PZz is mapped with the ith logical zone LZi, the zth physical zone PZz may be a zone state allocated in a mapping table 550 in FIG. 8. The allocated zone may refer to a physical zone allocated to store data requested to be stored in the ith logical zone LZi. In other words, data requested to be stored in the ith logical zone LZi may be stored in the plurality of pages included in the zth physical zone PZz.

The zth+1 physical zone PZz+1 and the zth+2 physical zone PZz+2 may be a free zone state not mapped to the logical zone. In other words, the plurality of pages included in each of the zth+1 physical zone PZz+1 and the zth+2 physical zone PZz+2 may be in an erased state in which data is not written.

An example embodiment illustrated in FIG. 9 may represent an example in which the ith logical zone LZi among the logical zones illustrated in FIG. 8 corresponds to the reset target zone. In an example embodiment illustrated in FIG. 9, the zth physical zone to the zth+2 physical zone PZz-PZz+2 may have different zone states, but example embodiments thereof are not limited thereto.

In an example embodiment illustrated in FIG. 9, when the memory controller receives a zone reset command for the ith logical zone LZi, which is the reset target zone, from the host, the memory controller may update the zth physical zone PZz corresponding to the ith logical zone LZi, which is the reset target zone, to an invalid zone in a mapping table 560. The invalid zone state may refer to a physical zone in which the written data has not been erased, but the data is no longer valid.

Also, the memory controller may map the ith logical zone LZi, which is a reset target zone, to the zth+1 physical zone PZz+1 among the zth+1 and zth+2 physical zones PZz+1 and PZz+2, which may be free zones in an example embodiment illustrated in FIG. 8. The memory controller may update the zth+1 physical zone PZz+1 to an allocated zone in the mapping table 560 in FIG. 9. In other words, the ith logical address LADDRi of the ith logical zone LZi may correspond to the zth+1 physical address PADDRz+1 of the zth+1 physical zone PZz+1. In the case that the zth+1 physical zone PZz+1 has a corresponding relationship with the ith logical zone LZi, data requested to be stored in the ith logical zone LZi may be stored in the plurality of pages included in the zth+1 physical zone PZz+1.

In the case that the zth+2 physical zone PZz+2 is not mapped to the logical zone, the zth+2 physical zone PZz+2 may be a free zone state in mapping table 560. In other words, data may not be written in the plurality of pages included in each zth+2 physical zone PZz+2.

In the case that the zth physical zone PZz has been updated to an invalid zone, the memory controller may perform a block erase operation on the erase target memory block among the memory blocks included in the zth physical zone PZz. Specifically, the memory controller may select the memory block in which data is written from among the plurality of memory blocks included in the zth physical zone PZz as the erase target memory block.

The memory controller in an example embodiment may select the zth physical zone PZz, which is an invalid zone state, with reference to the mapping table 560 and may select an erase target memory block included in the selected zth physical zone PZz. Thereafter, by partially performing block erase operations for the erase target memory blocks, respectively, in every period in which the memory controller does not perform the foreground operation, delay in performing the foreground operation may be reduced.

In the description, when the zone reset state of the storage device is the first state (S1), priority between the foreground operation and the block erase operation will be described in greater detail.

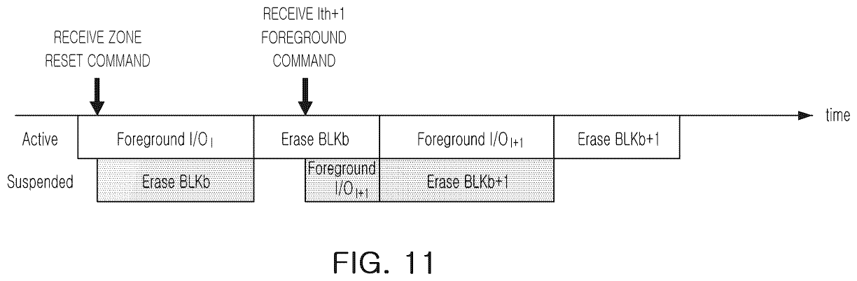

FIGS. 10 to 15 are diagrams illustrating performing of a foreground operation and a block erase operation when a zone state of a storage device is a first state according to an example embodiment.

The storage device may correspond to the storage device described with reference to FIGS. 1 to 9. An invalid zone may include memory blocks having consecutive block address values, and the invalid zone in an example embodiment illustrated in FIGS. 10 to 15 may include bth to bth+2 memory blocks BLKb-BLKb+2.

FIGS. 10 to 15 illustrate example embodiments in which a processor performs a foreground operation and a block erase operation for an invalid zone. When a processor performs an operation, the operation may be divided into an active operation which may be triggered and is currently performed, and a suspended operation which may not be triggered and is on standby to be performed. Referring to FIGS. 10 to 15, the active operation and the suspended operation may be distinct from each other with respect to the vertical axis. The horizontal axis may be time.

In an example embodiment, the processor may sequentially select the bth memory block BLKb having a smaller mapped address value as a current memory block and may trigger a block erase operation for the current memory block. For example, after the block erase operation for the bth memory block BLKb, the current memory block, is completed, the processor may update the bth+1 memory block BLKb+1 to be mapped to a subsequent address value of an address value of the current memory block BLKb to the current memory block.

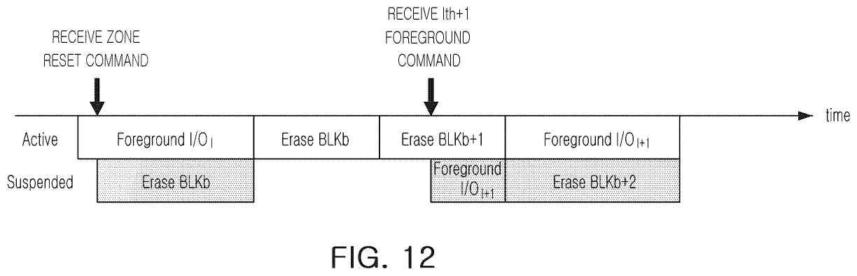

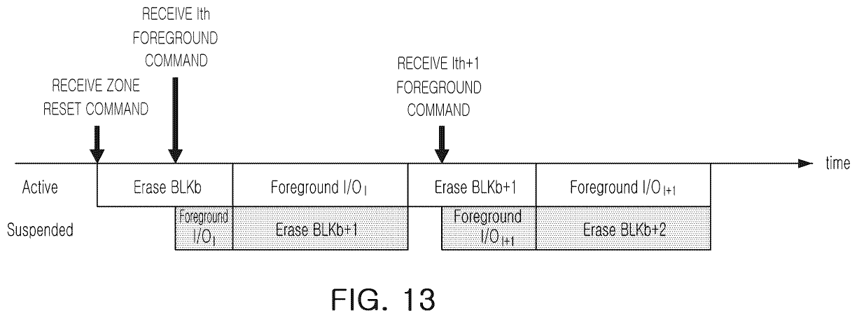

Referring to FIG. 10, FIG. 11, and FIG. 12, while the processor is performing an Ith foreground operation corresponding to an Ith foreground command, the host interface may receive a zone reset command. In the case that the processor is performing the Ith foreground operation, the block erase operation for the bth memory block BLKb, the current memory block, may be suspended. In other words, the Ith foreground operation may correspond to an active operation, and the block erase operation for the bth memory block BLKb may correspond to a suspended operation.

Referring to FIG. 10, the host interface may receive the Ith+1 foreground command in a period in which the processor performs the Ith foreground operation. In this case, the processor may trigger the Ith+1 foreground operation for the Ith+1 foreground command after the Ith foreground operation is completed, and may continue to suspend the block erase operation for the bth memory block BLKb, the current memory block. When there is an additional unprocessed foreground operation and a suspended block erase operation, the processor may preferentially trigger the additional unprocessed foreground operation when the foreground operation is completed.

Thereafter, the Ith+1 foreground operation may correspond to an active operation, and the block erase operation for the bth memory block BLKb may correspond to a suspended operation. When there are no other unprocessed foreground operations in the state in which the Ith+1 foreground operation is completed, the processor may trigger a block erase operation for the bth memory block BLKb, the current memory block. When the host interface receives the Ith+2 foreground command (e.g., an additional foreground command) after the block erase operation for the bth memory block BLKb is triggered, the processor may suspend the Ith+2 foreground operation for the Ith+2 foreground command. In other words, the block erase operation for the bth memory block BLKb may correspond to an active operation. Also, after the Ith+2 foreground command is received, the Ith+2 foreground operation may correspond to a suspended operation.

After the block erase operation for the bth memory block BLKb is completed, the processor may trigger the Ith+2 foreground operation for the Ith+2 foreground command. In other words, when an additional unprocessed foreground operation and an unprocessed block erase operation are pending in the state in which the block erase operation is completed, the processor may preferentially trigger the additional unprocessed foreground operation (e.g., triggering an additional foreground operation). Also, the processor may update the bth+1 memory block BLKb+1, which is mapped to the subsequent address value of the address value of the bth memory block BLKb, the current memory block, to a current memory block. In the case that the processor is performing the Ith+2 foreground operation, the block erase operation for the bth+1 memory block BLKb+1, the current memory block, may be suspended. The Ith+2 foreground operation may correspond to an active operation, and the block erase operation for the bth+1 memory block BLKb+1 may correspond to a suspended operation.

In an example embodiment, when there is no unprocessed foreground operation in the state in which the Ith+1 foreground operation is completed, the processor may trigger a block erase operation for the bth+1 memory block BLKb+1, the current memory block. Also, the processor may update the bth+2 memory block BLKb+2, which is mapped to a subsequent address value of an address value of the bth+1 memory block BLKb+1, the current memory block, to the current memory block.

Referring to FIG. 11, a zone reset command may be received while the processor is performing the Ith foreground operation. When there is no unprocessed foreground operation in the state in which the processor has completed the Ith foreground operation, a block erase operation for the bth memory block BLKb, the current memory block, may be triggered. While a block erase operation for the bth memory block BLKb is performed, the host interface may receive the Ith+1 foreground command. The processor may suspend the Ith+1 foreground operation for the Ith+1 foreground command until the block erase operation for the bth memory block BLKb is completed. The block erase operation for the bth memory block BLKb may correspond to an active operation. Also, after the Ith+1 foreground command is received, the Ith+1 foreground operation may correspond to a suspended operation.

After the block erase operation for the bth memory block BLKb is completed, the Ith+1 foreground operation for the Ith+1 foreground command may be triggered. In other words, when there is an additional unprocessed foreground operation and an unprocessed block erase operation, the processor may preferentially trigger the additional unprocessed foreground operation in a state in which the block erase operation is completed. In this case, the unprocessed block erase operation may be a suspended operation. Also, the processor may update the bth+1 memory block BLKb+1, which is mapped to the subsequent address value of the address value of the bth memory block BLKb, the current memory block, to the current memory block. In the case that the processor is performing the Ith+1 foreground operation, the block erase operation for the bth+1 memory block BLKb+1, the current memory block, may be suspended. The Ith+1 foreground operation may correspond to an active operation, and the block erase operation for bth+1 memory block BLKb+1 may correspond to a suspended operation.

When the host interface does not receive a foreground command while the processor is performing the Ith+1 foreground operation, the processor may trigger a block erase operation for the bth+1 memory block BLKb+1, the current memory block, after the Ith+1 foreground operation is completed.

In an example embodiment, when there is no other unprocessed foreground operation in the state in which the block erase operation for the bth+1 memory block BLKb+1 is completed, the processor may update the bth+2 memory block BLKb+2, which is mapped to the subsequent address value of the address value of bth+1 memory block BLKb+1, the current memory block. Thereafter, the processor may trigger a block erase operation for the bth+2 memory block BLKb+2, which is the updated current memory block.

Referring to FIG. 12, while the processor is performing the Ith foreground operation, the host interface may receive a zone reset command and may not receive the foreground command. In this case, the processor may trigger a block erase operation for the bth memory block BLKb, the current memory block, after the Ith foreground operation is completed.

When the host interface does not receive a foreground command while the processor is performing the block erase operation for the bth memory block BLKb, after the block erase operation for the bth memory block BLKb is completed, the processor may trigger the block erase operation for the bth+1 memory block BLKb+1, the updated current memory block. In other words, the block erase operations for the bth and bth+1 memory blocks BLKb and BLKb+1 may correspond to active operations.

Thereafter, when the host interface receives the Ith+1 foreground command after the processor triggers the block erase operation for the bth+1 memory block BLKb+1, the processor may suspend the Ith+1 foreground operation for the Ith+1 foreground command until the block erase operation for the bth+1 memory block BLKb+1 is completed. The block erase operation for the bth+1 memory block BLKb+1 may correspond to an active operation. After the Ith+1 foreground command is received, the Ith+1 foreground operation may correspond to a suspended operation.

After the block erase operation for the bth+1 memory block BLKb+1 is completed, the processor may trigger the Ith+1 foreground operation for the Ith+1 foreground command prior to the block erase operation for the bth+2 memory block BLKb+2. Specifically, the processor may update the bth+2 memory block BLKb+2, which is mapped to a subsequent address value of the address value of the bth+1 memory block BLKb+1, the current memory block, to the current memory block. In the case that the processor is performing the Ith+1 foreground operation, the block erase operation for the bth+2 memory block BLKb+2, which is the updated current memory block, may be suspended. The Ith+1 foreground operation may correspond to an active operation, and the block erase operation for the bth+2 memory block BLKb+2 may correspond to a suspended operation.

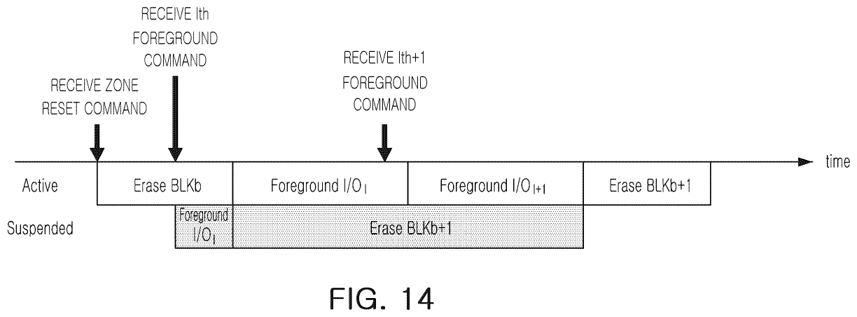

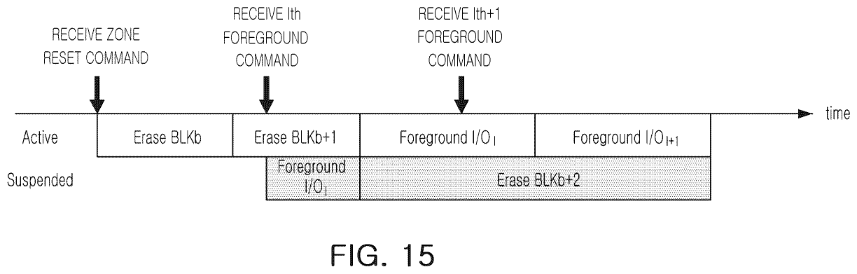

Referring to FIG. 13 and FIG. 14, the host interface may receive a zone reset command in a period in which the active operation is not performed, and the processor may trigger a block erase operation for the bth memory block BLKb, the current memory block. When the host interface receives an Ith foreground command before the block erase operation for the bth memory block BLKb is completed, the processor may suspend the Ith foreground operation for the Ith foreground command until the block erase operation for the bth memory block BLKb is completed. The block erase operation for the bth memory block BLKb may correspond to an active operation. After the Ith foreground command is received, the Ith foreground operation may correspond to a suspended operation.

After the block erase operation for the bth memory block BLKb is completed, the processor may trigger the Ith foreground operation for the Ith foreground command prior to the block erase operation for the bth+1 memory block BLKb+1. Specifically, the processor may update the bth+1 memory block BLKb+1, which is mapped to a subsequent address value of the address value of the bth memory block BLKb, the current memory block, to the current memory block. In the case that the processor is performing the Ith foreground operation, the block erase operation for the updated current memory block BLKb+1 may be suspended. The Ith foreground operation may correspond to an active operation, and the block erase operation for the bth+1 memory block BLKb+1 may correspond to a suspended operation.

Thereafter, referring to FIG. 13 as an example embodiment, in the case that there is no unprocessed foreground operation in the state in which the Ith foreground operation is completed, the processor may trigger a block erase operation for the bth+1 memory block BLKb+1, the current memory block. While the block erase operation for the bth+1 memory block BLKb+1 is performed, the host interface may receive the Ith+1 foreground command. The processor may suspend the Ith+1 foreground operation for the Ith+1 foreground command until the block erase operation for the bth+1 memory block BLKb+1 is completed. The block erase operation for the bth+1 memory block BLKb+1 may correspond to an active operation. Also, after the Ith+1 foreground command is received, the Ith+1 foreground operation may correspond to a suspended operation.

After the block erase operation for the bth+1 memory block BLKb+1 is completed, the processor may trigger the Ith+1 foreground operation for the Ith+1 foreground command prior to the block erase operation for the bth+2 memory block BLKb+2. Specifically, the processor may update the bth+2 memory block BLKb+2, which is mapped to a subsequent address value of the address value of the bth+1 memory block BLKb+1, the current memory block, to the current memory block. In the case that the processor is performing the Ith+1 foreground operation, the block erase operation for the updated current memory block BLKb+2 may be suspended. The Ith+1 foreground operation may correspond to an active operation, and the block erase operation for the bth+2 memory block BLKb+2 may correspond to a suspended operation.

Thereafter, in another example embodiment, referring to FIG. 14, the host interface may receive the Ith+1 foreground command in the period in which the processor performs the Ith foreground operation. In this case, after the Ith foreground operation is completed, the processor may trigger the Ith+1 foreground operation for the Ith+1 foreground command and may continue to suspend the block erase operation for the bth+1 memory block BLKb+1, the current memory block. In other words, in the state in which the Ith foreground operation is completed, the processor may preferentially trigger the unprocessed Ith+1 foreground operation. In the state in which the Ith foreground operation is completed, the processor may preferentially trigger the unprocessed Ith+1 foreground operation rather than the block erase operation for the bth+1 memory block BLKb+1. The Ith+1 foreground operation may correspond to an active operation, and the block erase operation for the bth+1 memory block BLKb+1 may correspond to a suspended operation.

Thereafter, when the host interface does not receive a foreground command while the Ith+1 foreground operation is performing, the processor may trigger a block erase operation for the bth+1 memory block BLKb+1, the current memory block, after the Ith+1 foreground operation is completed. That is, the block erase operation for the bth+1 memory block BLKb+1, the current memory block, may correspond to an active operation after the Ith+1 foreground operation is completed.

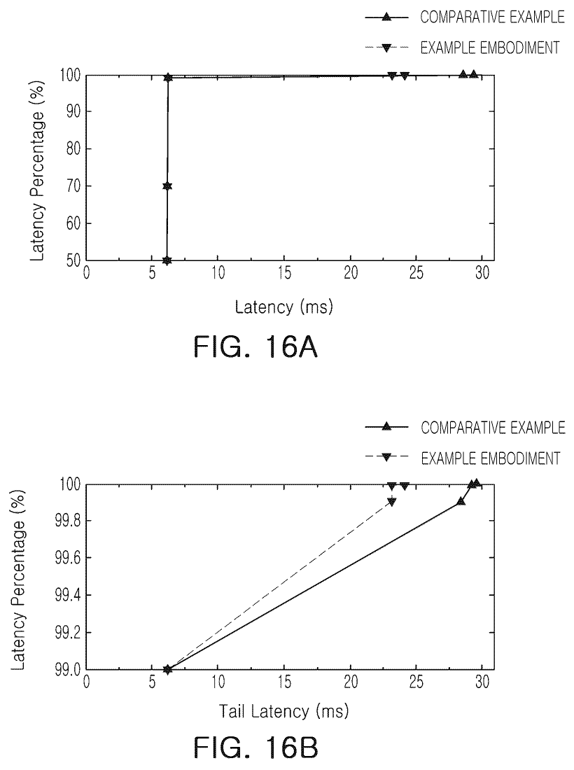

Referring to FIG. 15, the host interface may receive a zone reset command in a period without an active operation, and the processor may trigger a block erase operation for the bth memory block BLKb, the current memory block. When the host interface does not receive a foreground command while the processor is performing a block erase operation for the bth memory block BLKb, the processor may trigger a block erase operation for the bth+1 memory block BLKb+1, the updated current memory block, after the block erase operation for bth memory block BLKb is completed. In other words, block erase operations for the bth and bth+1 memory blocks BLKb and BLKb+1 may correspond to active operations.

Thereafter, when the host interface receives the Ith foreground command while the processor is performing a block erase operation on the bth+1 memory block BLKb+1, the processor may suspend the Ith foreground operation for the Ith foreground command until the block erase operation for the bth+1 memory block BLKb+1, the current memory block, is completed.

After the block erase operation for the bth+1 memory block BLKb+1 is completed, the processor may trigger the Ith foreground operation for an unprocessed Ith foreground command. The processor may update the bth+2 memory block BLKb+2, which is mapped to a subsequent address value of the address value of the bth+1 memory block BLKb+1, the current memory block, to the current memory block. In the case that the processor is performing the Ith foreground operation, the block erase operation for the updated current memory block BLKb+2 may be suspended. The Ith foreground operation may correspond to an active operation, and the block erase operation for the bth+2 memory block BLKb+2 may correspond to a suspended operation.

Thereafter, while the processor is performing the Ith foreground operation, the host interface may receive the Ith+1 foreground command. After the Ith foreground operation is completed, the processor may trigger the Ith+1 foreground operation for the unprocessed Ith+1 foreground command prior to the block erase operation for the bth+2 memory block BLKb+2. The block erase operation for the bth+2 memory block BLKb+2, the current memory block, may be continuously suspended. The Ith+1 foreground operation may correspond to an active operation, and the block erase operation for the bth+2 memory block BLKb+2 may correspond to a suspended operation.

The memory controller in an example embodiment and the storage device including the same may, by performing block erase operations for memory blocks included in an invalid zone, respectively, in every period in which the foreground operation is not performed, distribute the performing of the block erase operation. Accordingly, latency of the foreground operation may be reduced. For example, when a foreground command is received while a block erase operation for the bth memory block BLKb is performed, when the block erase operation of bth memory block BLKb is completed, the foreground operation may be performed prior to the block erase operation of the bth+1 memory block BLKb+1 and the bth+2 memory block BLKb+2, such that latency of the foreground operation may be reduced.

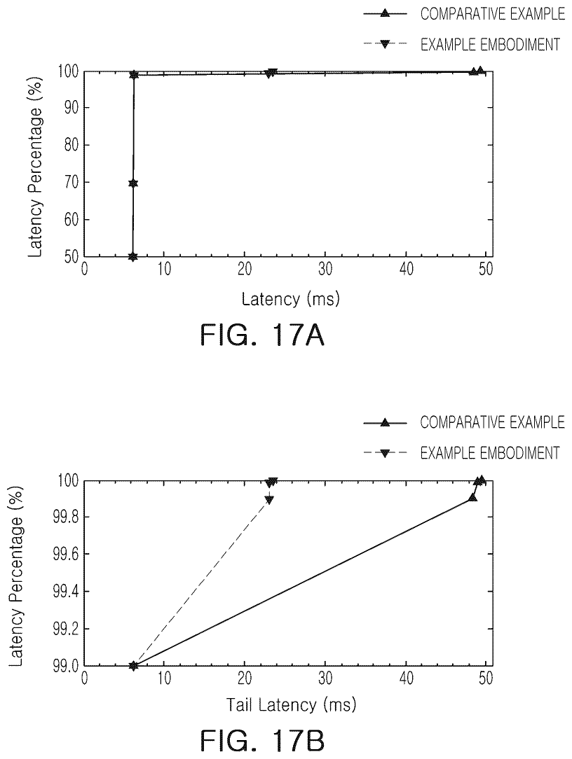

FIG. 16A, FIG. 16B, FIG. 17A, and FIG. 17B are diagrams illustrating a cumulative distribution function for a foreground operation latency of a storage device according to an example embodiment.

FIG. 16A, FIG. 16B, FIG. 17A, and FIG. 17B illustrate results of simulation of a foreground operation of a storage device described with reference to FIGS. 1 to 15. FIG. 16A, FIG. 16B, FIG. 17A, and FIG. 17B may be the results of performing simulation under the same conditions such as storage capacity, and different zone sizes. In an example embodiment, the memory devices applied to each of examples in FIG. 16A, FIG. 16B, FIG. 17A, and FIG. 17B may be divided into plurality of zones, and the simulation may be performed on each storage region within 256 GB (gigabytes).

The storage device applied to each in FIG. 16A, FIG. 16B, FIG. 17A, and FIG. 17B may include the same memory device. In an example embodiment, memory capacity of the memory device may be implemented to be 256 GB. A storage space may be configured on the memory device. In an example embodiment, a memory device may be divided into a plurality of physical zones, and each of the plurality of physical zones may include a plurality of memory blocks. Specific example embodiments may be similar to examples described with reference to FIGS. 4 and 5.

However, the memory devices applied to examples in FIGS. 16A to 17B may have different zone sizes. In an example embodiment, a zone size of the storage device in FIGS. 17A and 17B may be larger than a zone size of the storage device in FIGS. 16A and 16B. The storage device in FIG. 16A and FIG. 16B may be divided into 512 zones with a zone size of 512 megabytes (MB). The storage device in FIG. 17A and FIG. 17B may be divided into 256 zones with a zone size of 1 GB. However, example embodiments thereof are not limited thereto.

In an example embodiment, in the memory device applied in FIG. 16A and FIG. 16B, an invalid zone threshold value Tinvalid may be 1, and a free zone threshold value Tfree may correspond to 479. In the memory device applied in FIG. 17A and FIG. 17B, an invalid zone threshold value Tinvalid may be 1, and a free zone threshold value Tfree may be 239. Each of the storage devices applied in FIG. 16A, FIG. 16B, FIG. 17A, and FIG. 17B may be maintained in a state in which the number of free zones Zfree is greater than the free zone threshold value Tfree and the number of invalid zones Zinvalid is greater than or equal to the invalid zone threshold value Tinvalid. Accordingly, FIG. 16A, FIG. 16B, FIG. 17A, and FIG. 17B may illustrate results of simulation when the storage device is in a first state (S1), and the memory controller may sequentially trigger block erase operations for erase target memory blocks, respectively, in every period in which a foreground operation is not performed.

FIG. 16A, FIG. 16B, FIG. 17A, and FIG. 17B may represent a cumulative distribution function (CDF) for a foreground operation latency. FIG. 16A and FIG. 17A may indicate latency percentage for foreground operation latency, specifically indicating latency for foreground operations having a latency in the top 50%. Also, each in FIG. 16B and FIG. 17B may specifically indicate a tail latency of foreground operations having a latency in the top 1% in FIG. 16A and FIG. 17A. In FIG. 16A, FIG. 16B, FIG. 17A, and FIG. 17B, the unit of latency may be millisecond (ms), and the unit of latency percentage may be percentage (%).

FIG. 16A, FIG. 16B, FIG. 17A, and FIG. 17B may illustrate a cumulative distribution function for the foreground operation latency in each of an example embodiment and a comparative example. The storage device in an example embodiment may sequentially trigger block erase operations for memory blocks included in an invalid zone, respectively, in every period in which a foreground operation is not performed. The storage device in the comparative example, which is different from an example embodiment, may sequentially trigger block erase operations for the entirety of the memory blocks included in the invalid zone in a period in which a foreground operation is not performed.

Referring to FIG. 16A and FIG. 17A, in an example embodiment and the comparative example, the latency of about 6 ms may be the same at a latency percentage of cumulative distribution 50%-99%. In other words, 99% of the total foreground operations an example embodiment and the comparative example may be processed in a latency of about 6 ms. Also, in an example embodiment and the comparative example, the latency may increase significantly at a latency percentage of 99%-100% cumulative distribution. In other words, the remaining 1% of the foreground operation in an example embodiment and the comparative example may be significantly delayed, and the latency may correspond to a tail latency.

However, referring to FIG. 16B and FIG. 17B, the tail latency in the comparative example may increase more significantly than in an example embodiment. In an example embodiment illustrated in FIG. 16B and FIG. 17B, the same maximum tail latency, about 23 ms, may be exhibited regardless of zone size. Differently from the above example, in the comparative example, a maximum tail latency of about 30 ms may be exhibited in FIG. 16A, a maximum tail latency of about 50 ms may be exhibited in FIG. 16B, and as the zone size increases, the maximum tail latency may increase.

Referring to FIG. 16B and FIG. 17B, the maximum tail latency in an example embodiment may have a smaller value than the maximum tail latency of a comparative example, regardless of zone size. Also, a difference in maximum tail latency between an example embodiment and the comparative example in FIG. 17B may be greater than in FIG. 16B. In other words, in an example embodiment, the tail latency may be smaller than the comparative example, which is different from an example embodiment, and as the zone size increases, the difference in tail latency may increase.

The difference as above may occur depending on whether the block erase operation is performed in a distributed manner. The storage device in the comparative example, which is different from an example embodiment, may sequentially trigger block erase operations for the entirety of the memory blocks in a period in which the foreground operation is not performed, such that, after the block erase operation for the entirety of the memory blocks is completed, the foreground operation may be triggered. Accordingly, as the zone size increases, the number of included memory blocks may increase, and the maximum tail latency may increase as the zone size increases.

The storage device in an example embodiment may sequentially trigger block erase operations for the memory blocks, respectively, in a period in which the foreground operation is not performed, such that, after the block erase operation for one memory block is completed, the foreground operation may be triggered. By alleviating a difference in tail latency depending on zone size, a constant maximum tail latency may be obtained.

However, when the block erase operation is performed without referring to the write pointer of the invalid zone, the block erase operation may be performed on the entirety of memory blocks included in the invalid zone. The storage device in an example embodiment may perform a block erase operation only on selected erase target memory blocks among the memory blocks included in the invalid zone by referring to an address value of a write pointer of the invalid zone. In the description, a method of selecting the erase target memory block by referring to the address value of the write pointer will be described in detail.

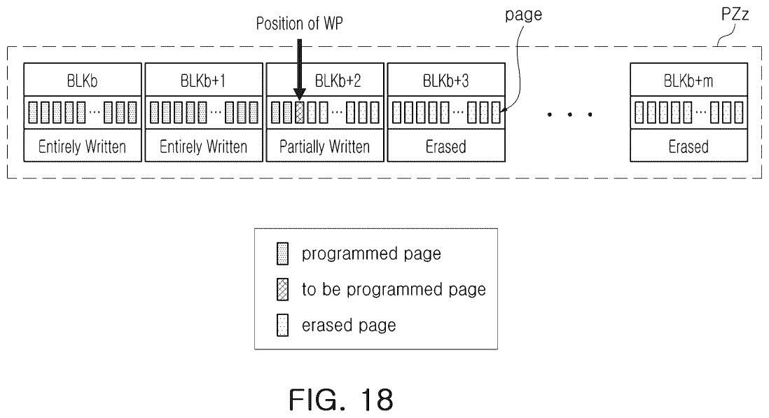

FIG. 18 is a diagram illustrating an invalid zone and a write pointer according to an example embodiment.

In an example embodiment, the storage device may include a memory device and a memory controller. A memory device may be divided into a plurality of physical zones, and a physical zone may correspond to a storage space obtained by dividing the memory device by zone units. The physical zone may include a plurality of memory blocks, and the memory block may include a plurality of pages. Specific example embodiments thereof may be similar to examples described with reference to FIGS. 4 and 5.

In an example embodiment illustrated in FIG. 18, the memory device may include a zth physical zone PZz, and the zth physical zone PZz may include a plurality of memory blocks BLKb-BLKb+m. The zth physical zone PZz may include m+1 memory blocks BLKb-BLKb+m, but an example embodiment thereof is not limited thereto. Also, each of the plurality of memory blocks BLKb-BLKb+m may include a plurality of pages. In an example embodiment, the memory block BLK may correspond to a minimum unit for controlling a data erase operation in a controller, and the page may correspond to a minimum unit of the write operation.

The memory block BLK may be mapped to a block address value, and as the number of the memory block BLK increases, the address value may increase. In the plurality of memory blocks BLKb-BLKb+m in an example embodiment illustrated in FIG. 18, as the number of memory block BLK increases, the address value mapped to the memory block BLK may increase. Specifically, the address value mapped to the bth+1 memory block BLKb+1 may be greater than the address value mapped to the bth memory block BLKb and may be smaller than the address value mapped to the bth+2 memory block BLKb+2.

A page may be mapped to a page address value, and as the number of the page increases, the address value mapped to the page may increase. The address values mapped to the pages included in a physical zone may be different. In other words, the address values mapped to the pages included in a memory block BLK may be different. By detecting the address value mapped to the page, in which memory block BLK a page is included or, in which physical zone PZ the element is included may be determined.

In an example embodiment, a physical zone may include a write pointer WP. The controller may store write pointers WPs of which the number may be the same as the number of physical zones included in the memory device. The write pointer WP may specify a position in which data is to be written. When the page corresponds to a minimum unit of the data write operation, the write pointer WP may be mapped to the page address value.

Before a data write operation for a physical zone is triggered, the write pointer WP may specify a page mapped to the smallest address value among the pages included in the physical zone. In other words, the write pointer WP may specify a starting position of data write operation in the physical zone.

In an example embodiment illustrated in FIG. 18, after the data write operation for a physical zone is triggered, the write pointer WP may specify a subsequent page in which data is to be written among the pages included in the physical zone. In other words, when a data write operation is triggered on a page mapped to the address value of the write pointer WP, the write pointer WP may move to the page in which subsequent data is to be written.

In an example embodiment illustrated in FIG. 18, the write pointer WP may refer to a page included in bth+2 memory block BLKb+2. In other words, the write pointer WP may be mapped to a page address value mapped to the page among the plurality of pages included in the bth+2 memory block BLKb+2.

The bth+2 memory block BLKb+2 may correspond to a state in which a portion of the memory block is partially written. A portion of the plurality of pages included in the bth+2 memory block BLKb+2 may correspond to pages in which data is written (programmed pages), and the other pages may correspond to pages in which data is erased (erased pages). Specifically, pages mapped to an address value smaller than the address value of the write pointer WP may correspond to the programmed pages. The page mapped to the address value of the write pointer WP may correspond to a page in which data is to be written. Pages mapped to an address value greater than the address value of the write pointer WP may correspond to pages in which a write operation has not been performed or written data has been erased.

Also, the bth and bth+1 memory blocks BLKb and BLKb+1 positioned prior to the write pointer WP may correspond to a state in which the memory block is written entirely. In other words, the pages included in the bth and bth+1 memory blocks BLKb and BLKb+1 may correspond to pages mapped to an address value smaller than the address value of the write pointer WP. Accordingly, the pages included in the bth and bth+1 memory blocks BLKb and BLKb+1 may be pages in which data is written (programmed page), such that data may be written.

Also, in the case that the write operation is not performed from the bth+3 memory block BLKb+3 positioned beyond the write pointer WP, the bth+3-bth+m memory block BLKb+3-BLKb+m may correspond to a state in which the memory block is erased. In other words, the pages included in the bth+3-bth+m memory block BLKb+3-BLKb+m may correspond to pages mapped to an address value greater than the address value of the write pointer WP. Accordingly, the pages included in the bth+3-bth+m memory block BLKb+3-BLKb+m may correspond to pages in which data has been erased (erased pages), such that data may not be written.

A storage device according to an example embodiment may correspond to the storage device described with reference to FIGS. 1 to 9. In an example embodiment illustrated in FIG. 18, the physical zone in the invalid zone state corresponding to the reset target zone may be zth physical zone PZz.

In an example embodiment, the processor may detect an address value of the write pointer WP of the zth physical zone PZz. The processor may select at least one erase target memory block among the memory blocks BLKb-BLKb+m included in the zth physical zone PZz by referring to the address value of the write pointer WP, and may trigger a block erase operation for the erase target memory block.

Specifically, the processor may select the bth-bth+2 memory block BLKb-BLKb+2 including a page mapped to an address value smaller than the address value of write pointer WP, from among memory blocks BLKb-BLKb+m included in zth physical zone PZz, as an erase target memory block. In other words, the processor may select the bth-bth+2 memory block BLKb-BLKb+2 in which data is written from among the memory blocks BLKb-BLKb+m included in the zth physical zone PZz as the erase target memory block.

Thereafter, the processor may sequentially select the bth memory block BLKb having a smaller mapped address value from among the bth-bth+2 memory blocks BLKb-BLKb+2, which are erase target memory blocks, as a current memory block, and may trigger a block erase operation for the bth memory block BLKb, the current memory block.

When the block erase operation for the bth memory block BLKb, the current memory block, is completed, the processor may update the bth+1 memory block BLKb+1 and the bth+2 memory block BLKb+2 mapped to a subsequent address value of the address value of bth memory block BLKb among the bth-bth+2 memory blocks BLKb-BLKb+2, erase target memory blocks, and may trigger a block erase operation.

The memory controller and the storage device including the same according to an example embodiment may perform a block erase operation only on memory blocks in which data is written entirely or partially using the address value of the write pointer WP. That is, the address value of the write pointer WP may define a target of the block erase operation. Referring to FIG. 18, a block erase operation may be performed only on a portion of memory blocks BLKLb-BLKLb+2 in which data is written entirely or partially. The block erase operation may be performed only on a portion of memory blocks BLKLb-BLKLb+2 in which data is written entirely or partially, rather than the entirety of the memory blocks BLKb-BLKb+m corresponding to the zth physical zone PZz. Accordingly, the block erase operations may not be performed on memory blocks in an erased state, and lifespan of memory blocks may be improved.

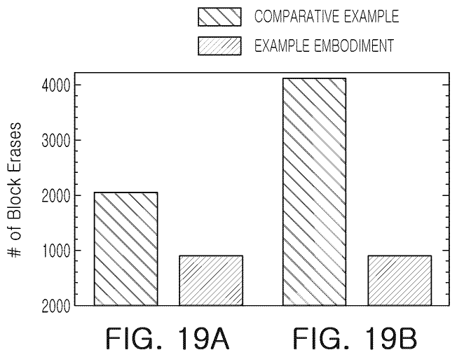

FIG. 19A and FIG. 19B are diagrams illustrating the number of performing a block erase operation of a storage device according to an example embodiment.

FIG. 19A and FIG. 19B illustrate results of simulation of a block erase operation of the storage device as described with reference to FIG. 18. FIGS. 19A and 19B may illustrate the result of performing simulation under the same conditions such as storage capacity of the storage device, and only different zone sizes. The storage device applied to each in FIGS. 19A and 19B may include the same memory device. In an example embodiment, memory capacity of the memory device may correspond to 256 GB.

Each of the memory devices applied to FIG. 19A and FIG. 19B may be divided into a plurality of physical zones, and the physical zone may correspond to a storage space divided by zone units. A physical zone may include a plurality of memory blocks, and a memory block may include a plurality of pages. Example embodiments thereof may be similar to examples described with reference to FIGS. 1 to 9, and FIG. 18.

However, the memory devices applied to each of FIG. 19A and FIG. 19B may have different zone sizes. In an example embodiment, a zone size of the storage device in FIG. 19B may be larger than the zone size of the storage device in FIG. 19A. The storage device in FIG. 19A may be divided into 512 zones having a zone size of 512 MB. The storage device in FIG. 19B may be divided into 256 zones having a zone size of 1 GB. However, example embodiments thereof are not limited thereto.

The storage device applied in FIG. 19A and FIG. 19B may be in a first state (S1) or a second state (S2). The memory controller in the first state (S1) may sequentially trigger block erase operations for erase target memory blocks, respectively, in every period in which a foreground operation is not performed. The memory controller in the second state (S2) may preferentially trigger a block erase operation for the entirety of erase target memory blocks. The memory controller in the second state (S2) may preferentially trigger the block erase operation for the entirety of erase target memory blocks rather than the foreground operation. However, example embodiments thereof are not limited thereto.

FIG. 19A and FIG. 19B may correspond to a diagram illustrating the total number of block erase operations according to a zone reset operation for a storage device applied to examples. In an example embodiment, the data write operation and the block erase operation may be performed multiple times for the entirety of the zone included in the memory device in FIG. 19A and FIG. 19B.

The storage device in an example embodiment may perform a block erase operation only on at least one erase target memory block among memory blocks included in an invalid zone by referring to an address value of a write pointer. The storage device in the comparative example, which is different from an example embodiment, may perform a block erase operation on the entirety of the memory blocks included in the invalid zone without referring to the address value of the write pointer.

Referring to FIG. 19A and FIG. 19B, the total number of block erase operations performed in the comparative example may be greater than in an example embodiment. In an example embodiment illustrated in FIG. 19A and FIG. 19B, the block erase operations may be performed approximately 900 times regardless of zone size. Differently, in the comparative example, the block erase operations may be performed approximately 2000 time in FIG. 19A, the block erase operations may be performed approximately 4000 times in FIG. 19B, and as the zone size increases, the block erase operations may be performed more.

Referring to FIG. 19A and FIG. 19B, the number of block erase operations performed in an example embodiment may be smaller than the comparative examples regardless of zone size. Also, a difference in the number of block erase operations performed between an example embodiment and the comparative example in FIG. 19B may be greater than an example in FIG. 19A. In other words, in an example embodiment, the block erase operation may be performed less than the comparative examples, which is different from an example embodiment, and as the zone size increases, the difference in number of the operation performed may increase.

The difference described above may occur depending on whether the memory block, which is a target of the block erase operation, is limited to the memory block in which data is actually written. The storage device in the comparative example, which is different from an example embodiment, may perform a block erase operation for the entirety of memory blocks included in the invalid zone. Accordingly, as the zone size increases, the number of memory blocks included may increase, such that as the zone size increases, the number of a block erase operation performed may increase.

The storage device in an example embodiment may limit a target of the block erase operation to a memory block including a page mapped to an address value smaller than an address value of a write pointer among memory blocks included in the invalid zone. Accordingly, the block erase operation may be performed only on memory blocks in which data is written regardless of zone size, such that the block erase operation may be performed predetermined times regardless of zone size.

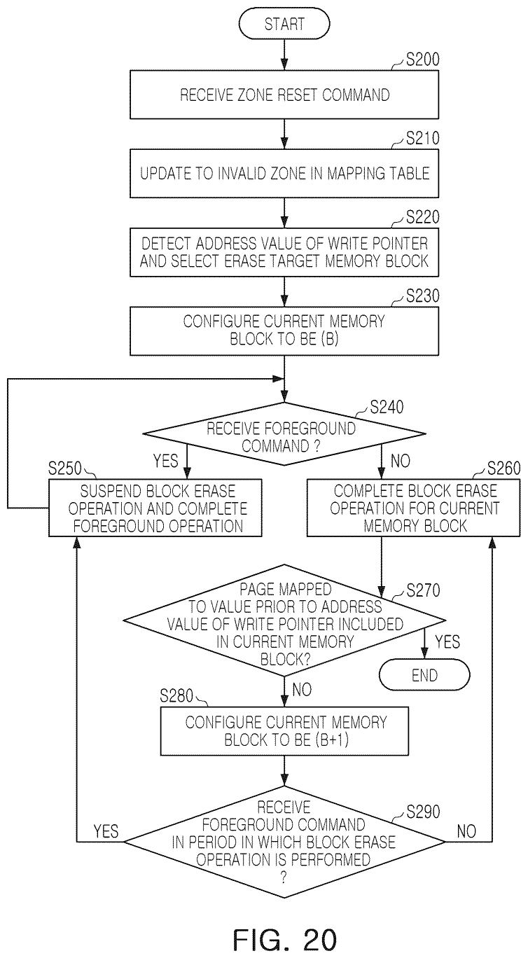

FIG. 20 is a flowchart illustrating a process in which a storage device performs a block erase operation according to an example embodiment.

A storage device according to an example embodiment may correspond to the storage device described with reference to FIGS. 1 to 19B.

A host interface may receive a zone reset command for a reset target zone among logical zones from a host (S200). Thereafter, the processor may update a physical zone corresponding to the reset target zone to an invalid zone in a mapping table (S210).

In an example embodiment, the processor may count the number of invalid zones and the number of free zones of the memory device when a zone reset command is received. Thereafter, the processor may compare the number of free zones of the memory device and the free zone threshold value with the number of invalid zones and invalid zone threshold value, and may determine a first trigger time point for the foreground operation and may determine a second trigger time point for the block erase operation based on results of the comparison.

The storage device according to an example embodiment illustrated in FIG. 20 may correspond to a first state (S1) in which the block erase operation may be sequentially triggered in every period in which the foreground operation is not performed. The processor may sequentially trigger block erase operations for at least one erase target memory block, respectively, among the memory blocks corresponding to the invalid zone in every period in which the foreground operation is not performed (S220-S290).

The processor may detect the address value of the write pointer in the invalid zone and may select an erase target memory block from among the memory blocks included in the invalid zone by referring to the address value of the write pointer (S220). Specifically, the processor may select a memory block including a page in which a mapped address value is smaller than the address value of the write pointer from among memory blocks included in the invalid zone as an erase target memory block.

Thereafter, the processor may sequentially select a block having a smaller mapped address value among erase target memory blocks as a current memory block and may trigger a block erase operation for the current memory block. In an example embodiment illustrated in FIG. 20, the processor may select the bth memory block as the current memory block (S230). The bth memory block may correspond to the memory block having the smallest address value among erase target memory blocks.

When the host interface receives a foreground command before receiving the zone reset command (YES in S240), the processor may suspend the block erase operation for the current memory block and may complete the foreground operation (S250). When the host interface does not receive the foreground command before receiving a zone reset command (NO in S240), the processor may trigger the block erase operation for the current memory block and may complete the block erase operation for the current memory block. (S260).

When the processor completes the foreground operation by receiving a foreground command before the host interface receives the zone reset command (YES and S250 in S240), the processor may determine again whether the host interface has received a new foreground command in a period in which the foreground operation is performed (S240). That is, the determination of whether the host interface has received a new foreground command in a period in which the foreground operation is performed (S240) may be iterative. However, example embodiments thereof are not limited thereto. For example, the processing may periodically check whether the host interface has received a new foreground command in a period in which the foreground operation is performed (S240).

In an example embodiment, when the host interface receives a new foreground command (YES in S240), the processor may continue to suspend the block erase operation for the current memory block and may complete a new foreground operation corresponding to a new foreground command (S250). In another example embodiment, when the host interface does not receive a new foreground command (NO in S240), the processor may complete the block erase operation for the current memory block (S260).

When the host interface does not receive the foreground command before receiving the zone reset command and the processor completes the block erase operation for the current memory block (NO and S260 in S240), the processor may determine whether the page mapped to the address value of the write pointer is included in the current memory block (S270).

In an example embodiment, when the page mapped to the address value of the write pointer is included in the current memory block (YES in S270), the block erase operation for the invalid zone of the processor may be terminated. When the page mapped to the value before the address value of the write pointer is included in the current memory block, the state may indicate that the block erase operation for the entirety of the memory block in which data is written among the memory blocks included in the invalid zone has been completed.

Thereafter, the processor may update the invalid zone in which the block erase operation has been completed to a free zone in the mapping table, and in the free zone data may be written again. Also, when the host interface receives a different zone reset command, the above block erase operation (S210-S290) may be performed repeatedly for the corresponding zone.

In another example embodiment, when the page mapped to the value before the address value of the write pointer is not included in the current memory block (NO in S270), the processor may configure the current memory block to be the bth+1 memory block (S280). In other words, when the block erase operation for the bth memory block, the current memory block, is completed, the bth+1 memory block mapped to the subsequent address value of the address value of the bth memory block, the current memory block, among the erase target memory blocks may be undated to the current memory block.

Thereafter, the processor may determine whether the host interface has received a new foreground command in the period in which a block erase operation for the current memory block before update is performed (S290). In an example embodiment, when the host interface does not receive a new foreground command in a period in which the block erase operation for the bth memory block is performed (S290 NO), the processor may complete a block erase operation on the bth+1 memory block, which is the updated current memory block (S260).

in another example embodiment, when the host interface receives a new foreground command in a period in which a block erase operation is performed on the bth memory block (S290 YES), the processor may suspend the block erase operation for the bth+1 memory block, which is the updated current memory block, and may complete the foreground operation corresponding to the new foreground command (S250). Thereafter, the processes of S240-S290 may be performed repeatedly.

The processor included in a storage device according to an example embodiment may select a memory block including a page mapped to an address value smaller than the address value of the write pointer among memory blocks included in the invalid zone as an erase target memory block. The processor may sequentially trigger the block erase operations for the erase target memory blocks, respectively, in every period in which the foreground operation corresponding to the foreground command is not performed.

Accordingly, by performing the block erase operation only on the memory block in which data is actually written, lifespan of the storage device may be improved. Also, by performing the block erase operations on the memory blocks in a distributed manner, a latency of the foreground operation may be reduced.

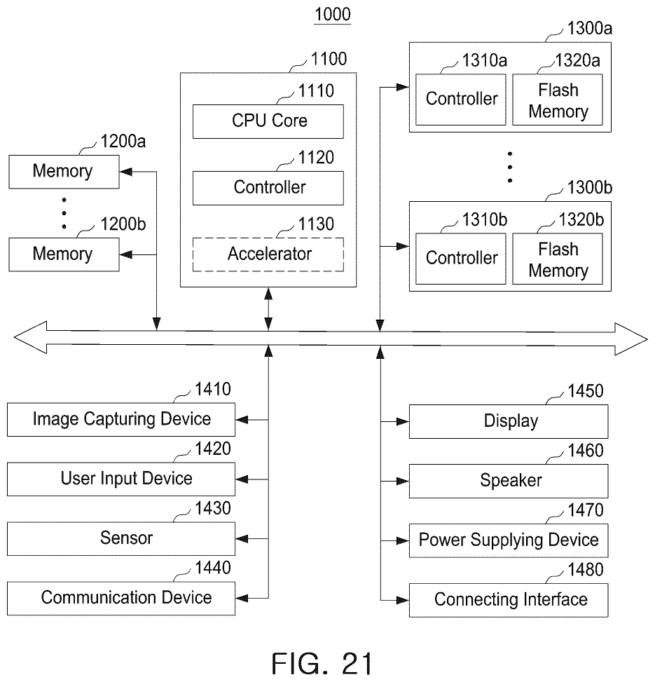

In the description, an example of a system to which an example embodiment may be applied will be described with reference to FIG. 21. FIG. 21 is a diagram illustrating a system to which a storage device is applied according to an example embodiment.

A system 1000 in FIG. 21 may be basically implemented as a mobile phone, smartphone, a tablet personal computer (tablet PC), a wearable device, a healthcare device, or a mobile system such as Internet of Things (IoT) devices. However, the system 1000 in FIG. 21 is not necessarily limited to a mobile system, and may be implemented as a personal computer, a laptop computer, a server, a media player, or an automotive device such as a navigation.

Referring to FIG. 21, the system 1000 may include a main processor 1100, memories 1200a and 1200b and storage devices 1300a and 1300b, and may further include an image capturing device 1410, a user input device 1420, a sensor 1430, a communication device 1440, a display 1450, a speaker 1460, a power supplying device 1470 and a connecting interface 1480.

The main processor 1100 may control overall operations of the system 1000, and more specifically, operations of other components included in the system 1000. The main processor 1100 may be implemented as a general-purpose processor, a dedicated processor, or an application processor.

The main processor 1100 may include one or more CPU cores 1110 and may further include a controller 1120 for controlling the memories 1200a and 1200b and/or the storage devices 1300a and 1300b. In an example embodiment, the main processor 1100 may further include an accelerator 1130, a dedicated circuit for high-speed data computation, such as artificial intelligence (AI) data computation. The accelerator 1130 may include a graphics processing unit (GPU), neural processing unit (NPU), and/or data processing unit (DPU), and may be implemented as a chip physically independent from other components of the main processor 1100.

The memories 1200a and 1200b may be used as main memory devices of the system 1000, and may include a volatile memory such as a SRAM and/or a DRAM, and may also include a nonvolatile memory such as a flash memory, a PRAM, and/or RRAM. The memories 1200a and 1200b may be implemented in the same package as the main processor 1100.

The storage devices 1300a and 1300b may function as nonvolatile storage devices for storing data regardless of whether power is supplied, and may have a relatively large storage capacity as compared to the memories 1200a and 1200b. The storage devices 1300a and 1300b may include storage device controllers 1310a and 1310b, and nonvolatile memory (NVM) 1320a and 1320b for storing data under control of the storage device controllers 1310a and 1310b. The nonvolatile memory 1320a and 1320b may include a flash memory having a two-dimensional (2D) structure or a three-dimensional (3D) vertical NAND (V-NAND) structure, or may include different types of nonvolatile memories such as PRAM and/or RRAM.

The storage devices 1300a and 1300b may be included in the system 1000 in a state of being physically separated from the main processor 1100, or may be implemented in the same package as the main processor 1100. Also, the storage devices 1300a and 1300b may have a form such as a solid state device (SSD) or a memory card, and may be detachably coupled to the other components of the system 1000 through an interface such as the connecting interface 1480, which will be described later. The storage devices 1300a and 1300b may be devices to which standard protocols such as universal flash storage (UFS), embedded multi-media card (eMMC), or nonvolatile memory express (NVMe) are applied, but example embodiments thereof are not limited thereto.

The storage devices 1300a and 1300b according to an example embodiment may detect an address value of a write pointer included in a physical zone and may perform a block erase operation for the physical zone using the value. In other words, the storage devices 1300a and 1300b may trigger block erase operations for at least one erase target memory block mapped to an address value smaller than the address value of the write pointer, respectively, in every period in which the foreground operation is not performed. Accordingly, by distributing the performing of the block erase operation, a latency of the foreground operation may be reduced and lifespan of storage devices 1300a and 1300b may be improved.

The image capturing device 1410 may obtain still images or moving images, and may be implemented as a camera, camcorder, and/or a webcam.

The user input device 1420 may receive various types of data input by a user of the system 1000, and may be implemented as a touch pad, a keypad, a keyboard, a mouse, and/or a microphone.

The sensor 1430 may sense various types of physical quantities obtained from an external entity, present externally of the system 1000, and may convert the detected physical quantities into electrical signals. The sensor 1430 may be implemented as a temperature sensor, a pressure sensor, an illumination sensor, a position sensor, an acceleration sensor, a biosensor, and/or a gyroscope sensor.

The communication device 1440 may perform signal transmission and reception between other devices present externally of the system 1000 in accordance with various communication protocols. The communication device 1440 may be implemented together with an antenna, a transceiver, and/or a MODEM.

The display 1450 and the speaker 1460 may function as output devices for outputting visual data and auditory data to a user of the system 1000, respectively.

The power supplying device 1470 may properly convert power supplied from a battery (not illustrated) embedded in the system 1000 and/or an external power source and may supply the power to each component of the system 1000.

The connecting interface 1480 may provide connection between the system 1000 and an external device which may be connected to the system 1000 and may exchange data with the system 1000. The connecting interface 1480 may be implemented by various interface methods such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, universal serial bus (USB), secure digital (SD) card, multi-media card (MMC), eMMC, UFS, embedded universal flash storage (eUFS), or compact flash (CF) card interface.

According to the aforementioned example embodiments, the storage device may reduce a latency of a foreground operation and may improve lifespan of the storage devices, by defining the erase target memory block by referring to the address value of the write pointer among the memory blocks included in the zone, a target of zone reset, and by performing block erase operations on erase target memory blocks in a distributed manner in a period when the foreground operation is not performed.

While example embodiments have been illustrated and described above, it will be configured as apparent to those skilled in the art that modifications and variations may be made without departing from the scope of the present disclosure as defined by the appended claims.

What is claimed is:

1. A storage device comprising:
a memory device including a plurality of memory blocks corresponding to a plurality of physical zones; and
a memory controller connected to the memory device,
wherein the memory controller is configured to, when receiving a zone reset command for a reset target zone, update a physical zone corresponding to the reset target zone among the plurality of physical zones to an invalid zone in a mapping table, and to trigger a block erase operation for a erase target memory block among a plurality of memory blocks included in the invalid zone in a period in which a foreground operation corresponding to a foreground command is not performed, and
wherein the memory controller is further configured to, when receiving an additional foreground command in the period in which the block erase operation is performed on a current memory block, trigger an additional foreground operation corresponding to the additional foreground command after the block erase operation for the current memory block is completed.

2. The storage device of claim 1, wherein the mapping table indicates a relationship between a plurality of logical zones and the plurality of physical zones, and
the memory controller is configured to select the erase target memory block from among the plurality of memory blocks included in the invalid zone with reference to an address value of a write pointer of the invalid zone.

3. The storage device of claim 2, wherein the memory controller is configured to select a memory block including a page mapped to an address value smaller than an address value of the write pointer as the erase target memory block.

4. The storage device of claim 1, wherein the memory controller is configured to select a memory block in which data is written from among the plurality of memory blocks included in the invalid zone as the erase target memory block.

5. The storage device of claim 1, wherein the memory controller is configured to sequentially select a block having a smaller mapped address value from among a plurality of erase target memory blocks as the current memory block and to trigger the block erase operation for the current memory block.

6. The storage device of claim 1, wherein the memory controller is configured to, when the block erase operation for the current memory block is completed, update a memory block mapped to a subsequent address value of an address value of the current memory block among a plurality of erase target memory blocks to the current memory block.

7. The storage device of claim 6, wherein the memory controller is configured to suspend a block erase operation for the memory block mapped to the subsequent address value in a period in which the additional foreground operation corresponding to the additional foreground command is performed.

8. A memory controller comprising:
a host interface configured to receive a zone reset command for a reset target zone among a plurality of logical zones from a host and a foreground command from the host;
a memory interface configured to control a memory device in response to the zone reset command and the foreground command; and
a processor configured to communicate with the host through the host interface and to communicate with the memory device through the memory interface,
wherein the processor is configured to, when the host interface receives the zone reset command, update a physical zone corresponding to the reset target zone to an invalid zone in a mapping table,
wherein the processor is further configured to detect an address value of a write pointer in the invalid zone, and to select a memory block including a page mapped to an address value smaller than an address value of the write pointer from among a plurality of memory blocks included in the invalid zone as an erase target memory block, and
wherein the processor is further configured to trigger a block erase operation for the erase target memory block, in a period in which a foreground operation corresponding to the foreground command is not performed.

9. The memory controller of claim 8, wherein the processor is configured to sequentially select a block having a smaller mapped address value as a current memory block and to trigger a block erase operation for the current memory block.

10. The memory controller of claim 9,
wherein the foreground command includes a first foreground command and a second foreground command,
wherein, when the host interface receives a second foreground command in a period in which the processor performs a first foreground operation corresponding to the first foreground command, the processor is configured to trigger a second foreground operation for the second foreground command after the first foreground operation is completed, and to suspend the block erase operation for the current memory block.

11. The memory controller of claim 9,
wherein the foreground command includes a first foreground command and a second foreground command,
wherein, when the host interface receives a second foreground command after the processor completes a first foreground operation corresponding to the first foreground command and triggers a block erase operation for the current memory block, the processor suspends a second foreground operation for the second foreground command until the block erase operation for the current memory block is completed.

12. The memory controller of claim 9,
wherein, when the host interface receives the foreground command in a period in which the processor performs the block erase operation for the current memory block, the processor is configured to suspend a foreground operation for the foreground command until the block erase operation for the current memory block is completed, and
wherein the processor is configured to, after the block erase operation for the current memory block is completed, update a memory block mapped to a subsequent address value of an address value of the current memory block among a plurality of erase target memory blocks, including the erase target memory block, to a current memory block, to trigger a foreground operation for the foreground command and to suspend a block erase operation for the current memory block mapped to the subsequent address value.

13. The memory controller of claim 9,
wherein, when the host interface does not receive the foreground command in a period in which the processor performs the block erase operation for the current memory block, the processor is configured to, after the block erase operation for the current memory block is completed, update a memory block mapped to a subsequent address value of an address value of the current memory block among a plurality of erase target memory blocks, including the erase target memory block, to a current memory block, and to trigger a block erase operation for the memory block mapped to the subsequent address value.

14. A storage device comprising:
a memory device including a plurality of memory blocks corresponding to a plurality of physical zones; and
a memory controller connected to the memory device,
wherein the memory controller is configured to, when receiving a zone reset command for a reset target zone among a plurality of logical zones from a host, to update a physical zone corresponding to the reset target zone to an invalid zone in a mapping table, and to trigger a block erase operation for an erase target memory block among a plurality of memory blocks included in the invalid zone,
wherein the memory controller is configured to determine a number of invalid zones and a number of free zones among the plurality of physical zones at a time of receiving the zone reset command, to compare the number of free zones with a free zone threshold value and to compare the number of invalid zones with an invalid zone threshold value, and
wherein the memory controller is further configured to determine a first trigger time point of a foreground operation corresponding to a foreground command received from the host and determine a second trigger time point of a block erase operation for the erase target memory block.

15. The storage device of claim 14, wherein a sum of the invalid zone threshold value and the free zone threshold value is less than a number of plurality of physical zones.

16. The storage device of claim 14, wherein the memory controller is configured to, when the number of free zones is less than or equal to the free zone threshold value, trigger a plurality of block erase operations for a plurality of erase target memory blocks, including the erase target memory block, preferentially over the foreground operation.

17. The storage device of claim 14, wherein the memory controller is configured to, when the number of free zones is greater than the free zone threshold value and the number of invalid zones is less than the invalid zone threshold value, preferentially trigger the foreground operation over a plurality of block erase operations for an entirety of a plurality of erase target memory blocks.

18. The storage device of claim 14, wherein the memory controller is configured to, when the number of free zones is greater than the free zone threshold value and the number of invalid zones is greater than or equal to the invalid zone threshold value, sequentially trigger block erase operations for a plurality of erase target memory blocks, respectively, in every period in which the foreground operation is not performed.

19. The storage device of claim 14, wherein the memory controller is configured to select a memory block including a page mapped to an address value smaller than an address value of a write pointer of the invalid zone from among the plurality of memory blocks included in the invalid zone as the erase target memory block.

20. The storage device of claim 14, wherein the memory controller is configured to sequentially select a block having a smaller mapped address value from among a plurality of erase target memory blocks, including the erase target memory block, as a current memory block and to trigger a block erase operation for the current memory block.
